(19) United States
(12) Patent Application Publication
(10) Pub. No.: US 2026/0014042 A1
(43) Pub. Date: Jan. 15, 2026

(54) Frame for Prone Positioning of Patients during Surgery

(71) Applicant: Kyra Medical, Inc., Northborough, MA (US)

(72) Inventors: Jesse DRAKE, Westborough, MA (US); Justin MCCARTHY, Boxborough, MA (US); Ryan CUNNIFF, Hopkinton, MA (US); Howard P. MILLER, Concord, MA (US)

(73) Assignee: Kyra Medical, Inc., Northborough, MA (US)

(21) Appl. No.: 18/766,838

(22) Filed: Jul. 9, 2024

(51) Int. Cl. A61G 13/12; A61G 13/02; A61G 13/10

(52) U.S. Cl. CPC A61G 13/129; A61G 13/02; A61G 13/101; A61G 2200/325

(57) ABSTRACT

An accessory for attachment to a surgical table that supports at least a portion of a patient's body, the accessory comprising at least one support structure having an adjustable length, a frame extending from a proximal end to a distal end, wherein the distal end of the frame is configured to be rotatably coupled to the surgical table and a multi-axis joint mounted onto the at least one support structure rotatably coupled to the proximal end of the frame, wherein the multi-axis joint has at least a first rotational degree of freedom about a tilt axis of the frame and a second rotational degree of freedom about an axis orthogonal to the tilt axis of the frame.

### BACKGROUND

The present disclosure relates to a frame that removably attaches to a surgical table to support portions of a patient's body during surgery. More particularly, the present disclosure relates to a frame that may be removably attached to surgical tables and configured for supporting a patient's arms, portions of the torso, the head and legs or other body parts during surgery, such as, for example, spinal surgery.

Standard surgical tables or beds, also referred to as surgical beds or operating room tables, have surgical accessory rails for mounting patient support devices used during surgical procedures, a support column, a base with patient support sections that are moved by electric linear or hydraulic actuators, to place a patient in a desired position. The surgical table may be height adjustable. The patient support section or sections can pivot or tilt relative to the base of the surgical table. These patient support sections may pivot or tilt together with same amount or degree relative to the base of the surgical table. The patient support sections of these standard surgical tables may have metal frames that may further include other metal elements which could interfere with a clinician's ability to obtain high resolution fluoroscopic images of a patient during surgery. High resolution images of these kind can be a critical element in ensuring the safe and effective implantation of screws, rods, replacement discs or other required hardware near nerves in the spinal cord or neck. Thus, many standard surgical tables are not suitable for spinal procedures or other orthopedic procedures.

Specialized surgical tables have been developed for spinal surgeries. For example, the “Jackson” table, the “Trios” table the, “Andrews” table and the Allen Advanced™ Table, have been designed specifically for spinal surgery. Examples of the “Jackson” table may be found in U.S. Pat. Nos. 5,088,706; 5,131,106; 5,613,254; and 6,260,220. An example of the “Andrews” table may be found in U.S. Pat. No. 5,444,882. An example of the Allen Advanced Table may be found in U.S. Pat. No. 2017/0354563 A1. These specialty tables include radiolucent spars that may allow for adjustment of the position of the patient intra-operatively. These various types of specialized self-standing surgical tables are very expensive and take up a great deal of valuable O.R. space when used or stored. Finally, these tables are only needed for a small percentage of the orthopedic or spinal surgeries that may be performed in a hospital.

The current art includes substantially radiolucent table extensions that removably attach to surgical tables allowing support of a patient during spinal or other surgical procedures during which x-ray, or fluoroscopic images are to be taken of the patient's upper body. See, for example, U.S. Pat. Nos. 4,995,067; 5,758,374; 6,003,174; 6,584,630; and 6,813,788. Each of the devices disclosed in the patents listed above include a tabletop or similar structure underlying the patient that may be removably attached to an underlying surgical table. In some surgical procedures in which a patient is in a prone position it is desirable for the patient's abdomen to hang downwardly without obstruction so as not to be supported by the underlying table surface. This is to allow blood to pool in the abdomen and away from the operative site, namely the spinal or cervical column. Accordingly, some table extensions having such tabletops or panels may not be suitable for some spinal surgery procedures. In addition, many of the known table extensions connect to an associated surgical table do not permit the extension to pivot relative to the surgical table in a manner that would permit flexure of a patient's torso by a sufficient amount to place the lumbar region of the patient's spine in a more lordotic (i.e., more arched) or more kyphotic (i.e., flattened or hunched) position than when the patient is simply lying in a flat, prone position with the lumbar region of the patient's spine in its naturally arched position.

Attempts have been made to address the above issues with radiolucent table extensions that pivot at the attachment point where they are removably coupled to the surgical table. These table extension include a rectilinear accessory frame with generally radiolucent spars that may be removably attached to a surgical table. Two radiolucent spars, which are rectilinear in their cross section, are spaced parallel to one another with support elements connecting the spars and forming a rectilinear frame. These frames come equipped with a variety of cushioned patient support devices which can removably attached for supporting a patient. These patient support devices include ones for supporting the chest, one for supporting the arms and legs; all of which may be moved or adjusted up and down the spars to facilitate safe positioning of the patient. These patient support devices have a latch that can be either in the locked or unlocked position. They are designed to prevent pressure ulcers, nerve damage and other problems caused by the patient being in a prone position during lengthy spinal procedures. The patient support devices must not move relative to the frame during surgery. To move or adjust their position they must be placed in the unlocked position. For example, a clinician may adjust their location on the spar to properly support a patient when unlocked and then lock them in place once the patient is positioned as desired. One example of such a frame with patient support devices is illustrated by U.S. Pat. No. 7,699,262B2 the “Allen Flex Frame.” This frame has a “U” shaped base to which it is attached that remains stationary on the floor unless tilted whereby its castors then contact the ground allowing it to be rolled from location to location. A first end of the rectangular radiolucent frame is removably attached to a surgical table while a second end of the frame is attached to a support structure with the support structure being both extendable upwards relative to the floor and retractable relative to the floor via a manual jack screw. There is a ball joint in the support base which is attached to the support structure at its lower end. The support structure at its upper end is attached to a first end of the frame. The ball joint allows the support structure to pivot around the support bas while the first end of the frame can tilt front to rear and side to side relative to the support base or the floor. The second end of the frame can pivot relative to the surgical table by means of a distal pivot member. This distal pivot member of the frame may be removably coupled to the distal end of a surgical table. The base is fixed from movement in this design. When articulated the dependent movements of the frame relative to the support structure, the support structure relative to the frame, the support structure relative to the surgical table and the frame relative to surgical table allows the prone positioning of the patient in a variety of positions. This facilitates the imaging of the patient's torso or spine while providing surgical site access for the clinician. Yet another attempt by ISO Medical of Japan fixes the top distal end of the frame and allows a wheeled base to move about an axis defined by the vertical support column which is attached to the wheeled base at its lower end and whereby the frame is fixed at the upper end of the support column.

Both above frames have two pivot axes of rotation: one at a first end of the frame and one at a second end of the frame while also allow movement about or around an axis bifurcating the base and generally perpendicular to the floor. More specifically these designs allow the:
a. rotation and tilting of the first end of the frame about an axis that is generally parallel to the floor and generally perpendicular to the support structure and
b. the motion of the first end of the frame about an axis that bifurcates the first end of the frame where it is coupled to the support structure, and which is generally perpendicular to the spars of the frame; and,
c. the second end of the frame to tilt upwards or downwards around an axis that and bisects the proximal pivot member where the frame and surgical table are removably coupled.

Patient support devices on the frames described above support portions of the patient's body and are configured to fit snuggly and tightly onto the spars of the frame. These patient support devices have a latch that while in the first position allows the devices to be moved up and down on the spars to place them in the desired position. Conversely, when the latch is in the second position, it clamps the patient support devices in place, thus preventing their unintended movement relative to the frame during the procedure and/or when the frame is articulated. It is crucial that these patient support devices remain in place during surgery and not move relative to the frame.

One drawback with the frame designs described, above is that as the support structure moves in space around about its base (while the top remains fixed) or about its top (while the base remains fixed) in response to the articulation of the surgical table the frame is subject to twisting and bending forces (torsion) which distorts the spars of the frame and may cause both the cross section of the spars and the frame to lose their rectangularity, and can cause damage or breakage of the spars. These bending and torsion forces are a result of the mismatch between the degrees of freedom of motion of the frame and that of the surgical table to which it is removably attached.

These temporary changes in the geometry of the spar members and/or of the frame may result in the patient support devices (formed to fit snuggly onto the spars) becoming unlatched, thereby allowing their uncontrolled movement relative to the frame during surgery. This loss of rectangularity of the spars may also result in the patient support devices becoming detached from the frame. Such uncontrolled movement and/or detachment of these patient support devices present a clinical hazard since uncontrolled movement of the patient during spinal surgery is very dangerous. Additionally, although frames in the current art fold and store onto their bases, the spars are too long to fit into the base or into the storage hooks of the base without the spars having an adjustment channel to allow them to be moved outwards from the support element to which they are attached. In addition these frames may require the removal of any patient support devices attached to the frame prior to storing it in the non-use position. This removal of patient support devices requires an extra step when the clinician is attempting to store the accessory frame onto the base.

### SUMMARY

Due to the described shortcomings in the current art, there is a need for a surgical frame for prone or spinal surgery, whose freedom of motion matches the freedom of motion of the surgical table to which it is removably coupled. This matching of degrees of freedom of movement between the frame and surgical table to which it is removably attached can eliminate the torsion and bending forces experienced by the frame and its spar members during use. This can prevent the uncontrolled movement or even detachment of the patient support devices during surgical procedures while allowing easy storage of the accessory with minimal steps. Also, breakage and/or cracking of the frame spars can be prevented.

At least one embodiment of the present invention comprises an accessory or accessory system that is used with a surgical table, as well as a method of using such an accessory or accessory system that has one or more of the features listed in the appended claims or one or more features or combinations thereof which alone or in combination may comprise patentable subject matter.

An accessory for attachment to a surgical table able to support portions of a patient's body during surgery comprises a rectilinear frame of radiolucent members (“spars”) with two such spaced spars being generally parallel to each other and connected by one or more spaced support members and/or pivot members generally perpendicular to the spars. The spars are rectilinear in shape. A support structure may have a base, a support column attached to the base and an adjustment column that extends upwards and away from and/or retracts downwardly into the support column. In some embodiments a lockable rotatable head may have a top surface, a bottom surface a distal horizontal surface and a proximal horizontal surface. The lockable rotatable head may be attached at its bottom surface to the top surface of the adjustment column. The rotatable head may rotate around an axis runs perpendicular to the floor and which runs down the center of the adjustment column and the support column and the floor. The rotatable head may have a recess formed in its distal horizontal surface into which the distal portion of a multi-axis joint may be coupled. This recess in the rotatable head may have a hole formed into its horizontal surface.

In one embodiment, the multi-axis joint may comprise a main clamp which has a circular cut out formed at its proximal end. The main clamp may also have a housing at its distal end with a single horizontal cutout bifurcating the housing. This bifurcation creates and upper and lower clamp housing. This bifurcation extends through the main clamp housing and may also bifurcate and a portion of the circumference of the circular cut out formed at its proximal end. The distal clamp housing has an upper clamp housing and a lower clamp housing and an upper (top) and bottom surface proximal surface. The lower clamp housing may have a horizontal channel or hole formed into its distal horizontal surface and which extends through a portion of its length. The upper clamp housing may have hole or recess formed into in its top surface, which is generally perpendicular to, and intrudes into, the horizontal hole or channel formed through a portion of the length of the lower clamp housing. A bevel stack washer or a stack of disc springs may be inserted into e vertical hole in the upper surface of the clamp housing with a cap placed over this hole after the stack washer is inserted therein. The operation and construction of a bevel stack washer system are well understood and will not be delineated here. When in place and capped the bevel stack washer applies constant pressure onto the upper and lower clamp housing working to close the gap caused by the bifurcation or cutout between them while simultaneously working to reduce the diameter of the clamp's rotational hub by closing the bifurcation or cut out made through the circular cutout of the main clamp.

The channel formed through a portion of the lower clamp housing may align with a hole formed into and through a recess formed into the proximal horizontal surface of a rotatable head in some embodiments with the hole exiting the distal horizontal surface of the rotatable head.

A proximal end of a rotatable cam may have a cam block formed or attached thereto. The distal end of the cam may have a handle attached thereto. The proximal end of this cam may be inserted and through the horizontal hole formed into and through the proximal and distal horizontal surfaces of the rotatable head. The cam with cam block may further be inserted into the horizontal channel formed through a portion of the length of the lower clamp housing. The cam block attached to or formed into the proximal end of the cam may be aligned once it is placed in this channel formed in the lower clamp housing and may align with the vertical hole formed into and through the upper clamp housing and which exits into the horizontal channel of the lower clamp housing.

The distal end of the cam with the cam block may have a handle that when rotated can move the cam from a first position to a second position. The cam block on the proximal end of the cam may interact with the lower end or bottom surface of a bevel washer formed or disc spring stack that has been placed into the horizontal hole formed through the upper clamp housing. When placed in a second position, proximal end of cam with the cam block interacts with the bottom of the bevel washers or stack of disc springs and pushes upward against it. This interaction between the cam block and the bevel stack washer exerts upward force against the bevel stack washer relieving the pressure exerted by the bevel stack washer on the upper and lower clamp housings and on the bifurcation made in the circular cut out of the main clam and thus allows the horizontal cut-out formed through the clamp housing and the cut out made through a portion of surface of the main clamp's circular cut out to open up and thus increase the diameter of the circular cut out portion of the main clamp.

A suitable metal may be used to form rotational hub. The rotational hub may be circular may be in circular in shape with outer circumference and may be flat on its side surfaces with a hole formed though its center and four through holes formed around the center hole. Two round semi-spherical segments made of a suitable material or metal may be placed around the circumference of the rotational hub. The semispherical segments have an outer circumference and with a curved surface and inner circumference with curved surface and with both surfaces having a shared radius. The outer surface of the semisphericals may be mated with the outer surface/circumference of the rotational hub. The rotational hub with the two semisphericals mated to its outer surface may be placed into the circular cut out portion of the main clamp. The circular cut out portion of the main clamp may be formed so that it mates closely with the rotational hub mounted semisphericals. The combined half semisphericals and rotational hub combination may be contained inside the circular cut out of the rotational hub by the placement of a yoke pivot member through the center of the two semisphericals and the center hole of the rotational hub and with each end of the yoke pivot member being attached to the first clevis end of a yoke. Circular cover plates may be sized to match the outer circumference of the rotational hub. The circular cover plates may have one hole formed in their center and sized to accept the yoke pivot member and four through holes that match with the four holes formed through the rotational hub. The circular cover plates also may have four holes located and formed around the center hole. The yoke pivot member may have a fixation pin fitted through holes formed at or near each end of the pivot member. The yoke pivot member may be round, and in some embodiments, and it may be threaded at one or both ends. In other embodiments the yoke pivot member may have a hole formed near each of its each end. In other embodiments, the yoke pivot member may have a cap at one end and be threaded at the other end. Fixation bolts may be placed through the four through holes formed in a first circular plate. These fixation bolts may be pushed through and out of matching fixation holes in the rotational hub and fitted into and through four holes formed into an opposing second circular plate fitted to the opposing side of the rotational hub. The fixation bolts may be capped at one end and secured to the cover plates by placing a lug on exposed threaded ends of the fixation bolts. A yoke may have first and second clevis ends with holes in each end.

The yoke pivot member may be placed through the holes in one clevis end of the yoke and then through the hole formed in the center of a first circular cover plate and then passed through the center of the hole in the rotation hub then out through the rotation hole formed in the center of the second cover circular plate. The ends of the yoke pivot bolts maybe threaded and may be capped by a lug. The threaded ends of the yoke pivot member can then be capped by lugs creating a multi-axis joint out of this rotational hub-main clamp-semi spherical assembly.

The cam of may be placed in a second position which allows the bevel or spring stack washers to apply pressure to the upper and lower housing of the rotational hub, thereby closing the gap between its upper and lower housing, decreasing the diameter of the circular cutout portion of the rotational hub. When this occurs, pressure is applied to the semi-sphericals mated to the inner circumference of the of the rotational hub thus locking the semi-sphericals and the multi-axis joint assembly against motion.

Conversely, when the cam is turned to a first position, the cam block of the cam pushes against the bevel stack or disc spring stack and relieves the pressure exerted on against upper and lower housing of the clamp and the cut out in the surface of the rotational hub. The relief of the pressure exerted by inner surface of the circular portion of rotational hub against the mated outer surface of the half semi spheres unlocks the multi-axis joint thereby allowing its movement.

Some embodiments include a yoke that connects the multi-axis to the first end of a frame. The yoke may have a first clevis end with matching through holes in each of its two tangs and a second clevis end with matching through holes in each of its two tangs.

In one embodiment, the threaded ends of the yoke pivot member protruding from the circular plates of the multi-axis joint may be placed into and through the though holes in each tang of the first clevis end of a yoke. In this embodiment, lugs may be placed on the protruding threaded ends thus attaching the first clevis end to of the yoke to the multi-axis joint.

In other embodiments the yoke pivot member may be fitted with a cotter or fixment pin placed through holes formed in each end of the yoke rotation member to secure it in place.

The yoke may have an opposing second clevis end opposing the first clevis end of the yoke. The second clevis end of the yoke may be attached to a first end of the frame by at least one distal pivot member. In some embodiments there may be two distal pivot members. The distal pivot member or members may be threaded at each end. In some embodiments, the distal pivot member is round in cross section. The distal pivot member can be inserted through a though hole in one tang of the second clevis end of the yoke and then into and through holes formed in the distal region of each spar and then into the opposing through hole in the second clevis end of the yoke and capped by a lug at the threaded ends of the distal pivot member thus coupling one end of the yoke to the first end of a frame.

In one embodiment, the rotatable head, multi-axis joint and yoke comprise, with their associated pivot members and rotatable elements, a gimbal that in combination with the proximal pivot member attaching the frame to the surgical table allows the rectilinear frame to move or articulate about six axes of rotation. Up to two of the axes of rotation may be locked against rotation by placing the cam of the multi-axis joint in the second position in one embodiment. The rotatable lockable head may also be locked against rotation by a lever inserted into the rotatable lockable head that when placed in the second position impinges upon the head blocking any rotation. When in the first location this lever allows the rotatable lockable head to rotate as desired.

The accessory may further have a proximal coupler which allows a second end of the rectilinear frame to be pivotably coupled to the surgical table such that two of the spars extend away from the surgical table with the rectilinear frame able to be articulated relative to the surgical table in response to portions of the surgical table being moved and/or in response to the movement of the support or adjustment column. The spars may be configured so that two of the spars maybe generally parallel with each other with at least one support member attaching the spars to one another and with such support element or elements being generally perpendicular to the spars.

The spars may be spaced and arranged such that the upper body of a patient may be supportable by the accessory and at least a portion of the patient's legs may be supportable by the surgical table during surgical procedures. The frame may have at least one pivot member connecting the spars at its second end. The distal and proximal pivot members of the first and second ends of the frame are generally parallel to each other and generally perpendicular to the spars of the frame. There may be a pivot member at the first end of the frame while there may also be a pivot member at a second end of the frame. In other embodiments, there may be two pivot members at a first end of the frame and at least one pivot member at the second end of the frame. A pivot member may also act as support structure extending from the inward surface of at least one spar to the inward surface of the opposing spar.

In other embodiments the first end of the frame is attached to the second clevis end of the yoke by two or more pivot members rather than a single pivot member. The pivotable coupling using a proximal pivot member between the surgical table and the second end of the frame allows an associated patient's spine to be made more lordotic or kyphotic prior to, during and after the surgical procedure by simply by or raising the surgical table and/or raising or lowering the adjustment column of the accessory. The distal pivot member or members attaching the first end of the frame to a second clevis end of a yoke allows the first end of the frame to pivot up and down relative to the base of the accessory and to the base of the surgical table to which the frame is removable coupled. Each side of the frame can be made to move up and down relative to the base of the surgical table when the adjustment column is raised or lowered and/or if the surgical table is raised or lowered. Furthermore, the frame can be made to move side to side in response to the motion or articulation of the surgical table. This is accomplished by the axes of rotation of the rotatable head, and the multi-axis joint which, in turn, is attached to the first clevis end of the yoke and the second clevis end of the yoke which is coupled to the first end of the frame by a pivot member.

When the rotatable cam is in the second position, unlocking the multi-axis joint and allowing motion of the yoke to which the multi-axis joint is attached and the frame to which the yoke is attached allows the multi-axis joint to rotate in reaction to the motion of the surgical table while it is articulated and the motion of the adjustment column as it is moved.

Furthermore, when the cam is in the second position, the multi-axis joint is then locked against its motion and simultaneously prevents motion of the frame in at least two axes. The articulation of the surgical table through its ranges of motion may be accomplished using one or more electric linear actuators of the surgical table as an example.

Patient support devices may have a channel formed in their length designed to fit snuggly onto the spars. The patient support devices may be removably attached to the spars and may have latches with a locked and an unlocked position. Portions of patient's body may be positioned onto the patient support devices. When in the locked position the patient support devices cannot be moved along the spars. When in the unlocked position the patient support devices may be moved along the spars allowing these patient support devices to be positioned under the patient's body as desired. The patient support devices may include ones for supporting the chest, arms, and hips, and other parts of the body.

The patient support devices may be coupled to the spars and may include head supports, chest supports, hip supports, arm-boards (arm supports) and leg supports among others. The accessory may be used without panels or table sections which extend beneath the patient's abdomen, thereby allowing the patients abdomen to hang downwards without any obstruction. Panels or sections may be attached to the radiolucent spars and may support mattress cushion pads. The coupler between the second end of the frame and the distal end of the surgical table may comprise at least one proximal pivot member which extends generally horizontally from at least one of the spars. The coupler may further comprise at least one proximal clamp that is couplable to a surgical table and that is able to receive the proximal pivot member which allows the pivoting movement or rotation of the second end of the frame around the generally horizontal axis of the pivot member. The proximal clamp may also comprise a clamp body with a channel sized to receive an accessory rail of the surgical table and tightening screw that may press against the accessory rail and a tightening knob removably coupling the proximal clamp to the surgical table. The clamp may include a spring loaded toggle arm extending from the body of the clamp while the clamp may have a curved surface or an aperture on which the proximal pivot member may be and captured by the spring loaded toggle arm. In addition, the clamp may have a second tightening screw or system which compresses the rail acceptance channel onto surgical table side rail.

The proximal pivot member may have groves or spirals formed around its circumference and threaded ends. The proximal pivot member also may have a circular catch plate attached to each of its ends. Each spar may have an end cap fitted to its proximal end. The spar proximal end caps may have a spring-loaded actuator located in a channel formed through it. When the spring-loaded actuator is in the neutral position it exerts pressure onto and prevents movement of the proximal pivot member. When pressed or pushed, the actuator enables outward motion of the distal pivot member and catch plates attached to it, thereby allowing the distal pivot member to be removably attached to a variety of widths of surgical tables.

The proximal pivot member may have catch plates with threaded holes which may be attached to the threaded ends of the proximal pivot member. During articulation of the frame relative to the surgical table, the proximal pivot member may rotate and slide on the curved surface of the aperture formed into one end of the proximal clamp.

The proximal clamp may have a spring-loaded toggle arm that is moveable between a second position that locks when in the neutral position and that when moved into a second position allows removal of the proximal pivot member from the aperture of the clamp.

Each spar may comprise a carbon fiber tube and a filler material within the tube. The filler may comprise a polyurethane foam material. The tube or spar may be generally quadrilateral in cross section. In some embodiments the spar may be about 1.25 inches (3.175 cm) in width and about 1.5 inches (about 3.80 cm) in height. In some embodiments at least two spars may be generally parallel to each other and spaced 14 inches (about 35.6 cm) apart as measured between the inside of facing surfaces or about 17.5 inches (about 44.5 cm) as measured from outside surface of one spar to the outside surface of the opposing and generally parallel spar. In these embodiments, having the frame comprised of spar members in this arrangement may allow any patient support accessory which may be otherwise attachable to the Jackson, Allen Advanced or other specialty tables, to be attached to spar members of such frame embodiments above.

Further to this disclosure, an accessory that is attachable to a surgical table to support a patient during surgery which may be removably attached to a surgical table to support a patient that may be stored when not in use. This storable accessory may comprise a frame that is generally rectilinear in shape having at least two radiolucent spars that are rectilinear in cross section with such spars being generally parallel to each other and with at least one support member connecting the spars. At least one pivot member extends outwardly from the medial surface of one spar and connects it to the opposing spar. In some embodiments, the at least one pivot member act as the structural member connecting the two spars. In other embodiments, there is at least one pivot member and one support member extending outwardly from the medial surface of one spar and connected to the opposite spar. The at least one pivot member or support member is generally perpendicular to the spars.

The accessory may further have an accessory base with a support column coupled to the base. The support column is generally perpendicular to the floor and the base. The support column may have an adjustment column that nests within it and that also extends into and out of it. The support column may further have electric linear actuators that can move the adjustment column outward and upwards from the support column or which may pull the adjustment column downwards into the support column.

In some embodiments, there may only be one support column that extends out of the base that is driven up and down by linear actuators nested within the column. The base may include a rectilinear or u-shaped base frame and a pair of hooks. In other embodiments the based may be quadrennial in shape or it may be shaped in the form of an “X” with a central area upon which the support column is affixed. The base may be weighted to enhance anti-tipping properties of the accessory. In other embodiments the base may include a base frame with cut outs, or a notch formed into the top surface the base to accept a second end of the frame when the accessory is not in the use position.

The frame may have one or more pivot members extending outwardly relative to the radiolucent spars at the first and second end of the frame. One or more of the pivot members at the second end of the frame may rest on the hooks formed or fitted onto the top or side of the base. In other embodiments, the at least distal one pivot member may rest in base cutouts formed in the shape of a “V” in the upper surface of the base when the frame is in the storage position. In other embodiments, hooks may extend from one side of the base. In some embodiments, the hooks may extend from two sides the sides of the base. In other embodiments, the hooks may extend upwards from the front top surface of the base. The hooks may be formed into or fitted onto the surface of the base.

A surgical table may have a base with column that by using electric linear actuators allows the surgical table to be raised or lowered and tilted during or before surgery. The surgical table may have side rails running longitudinally along its length onto which patient support devices may be mounted.

The accessory may further have a pair of distal clamps that are couplable to the side rails of the surgical table. A proximal pivot member of the accessory may be couplable to the distal clamps when the frame is in the use position. The distal clamps may be removably attached to side rails at the distal region of the surgical table.

A gimbal may comprise rotatable head attached at its lower surface to the upper region of the adjustment column, or in some embodiments at the top surface of the adjustment column, and a multi-axis joint coupled to the proximal horizonal surface of the rotatable head which is attached at its proximal end to a yoke with two clevis ends. The rotatable head may be rotatable and lockable with the axis of rotation being generally perpendicular to the floor and parallel to the adjustment column. The multi-axis joint may have a cam inserted into it which allows rotation around at least three axes when the cam is in the first position and simultaneously locked against rotation around at least two of these axes when the cam is in the second position. The multi-axis joint may rotate around three axes of rotation simultaneously including a first axis which is generally parallel to the floor and perpendicular to the frame (the horizontal multi-axis joint axis) and allowing up to 360° of rotation around this axis. The multi-axis joint may rotate around a second axis generally perpendicular to the floor and parallel to the adjustment column (the perpendicular joint axis) and allowing of up to approximately 25° of rotation around this axis. Finally, the multi-axis joint may rotate around a third axis which is generally parallel to the floor and parallel to the spars of the frame and allowing of up to approximately 25° around this axis. These axes of rotation are shown in FIG. 1.

A yoke may have opposed first, and second clevis ends. A yoke pivot member may be located on and protruding from the opposing cover plates of the multi-axis joint. The first yoke clevis end may have holes formed into it into which the yoke swivel member may be inserted and capped thus coupling the first clevis end of the yoke to the multi-axis joint.

The spars at the first end of the frame may be attached to the first clevis end of the yoke by a distal pivot member in some embodiments with the pivot member being generally perpendicular to the spars. In other embodiments the spars at the first end of the frame may be attached to a first clevis end of a yoke by two pivot members. The second clevis end of the yoke may be attached to the multi-axis joint via a yoke pivot member protruding from the multi-axis joint. The multi-axis joint may allow movement in three axes and may be lockable against rotation around two of these axes when the rotatable cam is in the second position. The rotatable head to which the multi-axis joint is coupled may be fitted onto a mount place attached at the top region of the adjustment column. The mount place may be configured to allow the rotatable head to rotate up to approximately 45° in a plane generally parallel to the floor.

A second end of the frame may be removably attached to the distal end of a surgical table by a proximal pivot member. gimbal can comprise: a yoke with two clevis ends with a second clevis end coupled to a distal pivot member or members, a multi-axis joint allowing motion in three axes of rotation, and which is lockable against any motion around two these axes of rotation and which is attached at its proximal end to a first clevis end of the yoke, and a lockable rotatable head which is attached to the distal side of the multi-axis joint.

The distal pivot member or in some embodiments, distal pivot members, may be attached to one clevis end of a yoke. The distal pivot member may also be attached to the first end of the frame.

The gimbal allows the first end of the frame to pivot about the generally parallel axes of the yoke support pivot member and the distal pivot member when the adjustment column is raised and lowered and/or as the surgical table is raised and lowered.

The multi-axis joint has a yoke pivot member protruding from cover plates coupled to the two outside horizontal surfaces of the multi-axis joint. The yoke pivot member may connect the multi-axis joint to the second clevis end of the yoke while a distal pivot member may attach the first clevis end of the yoke to the first end of the frame.

A multi-axis joint can allow for rotational motion about at least five axes including at least the following axes:
Axis of rotation E-E running through the rotatable head that is generally perpendicular to the floor and that runs, generally, through the center of the adjustment column and the support column in which it nests.
Axis of rotation C-C that is generally parallel to the floor and runs generally through the center of the multi-axis joint.
Axis of rotation D-D runs that runs through the multi-axis joint that is generally perpendicular to the floor and generally parallel to the adjustment column.
Axis of rotation F-F that runs through the multi-axis joint that is generally perpendicular to the adjustment column and generally parallel to the floor and generally runs along the longitudinal axis of the frame and generally bifurcates the surgical table.
Axis of rotation B-B that runs through the distal pivot bolts attaching the first clevis end of a yoke to the first end of the frame.
Axis of rotation A-A in which the frame rotates around a proximal pivot member with the axis being generally parallel to the floor and axis of rotation B-B.

The multi-axis joint may be able to be simultaneously locked against at least two axes of rotation. The attachment of the second end of the frame to the distal end of a surgical table by the proximal pivot member may further allow pivoting of the frame about the lateral and longitudinal axes of the spars extending from the support column. This pivoting around the axis of the proximal pivot member may occur because of the operation of linear actuators in the surgical table that raise and lower it, or because of the raising and lowering of the adjustment column.

Linear actuators in the surgical table may tilt the table relative to the floor and articulate the surface of the table up to an angle of up to approximately 60° relative to a plane perpendicular to the floor. Specifically, the multi-axis joint and the yoke to which the frame is attached allows the frame to tilt around an axis that runs parallel to the surface of the surgical table and the floor as the surgical table is articulated about these planes.

The gimbal allows the first end of frame to move side to side in a plane parallel to the floor as the surgical table articulates through its ranges of motion. The gimbal also allows the frame to which it attached to move side to side in a plane parallel to the floor as the surgical table is tilted at an angle to the floor and as the head section is lowered and the foot section is raised (the “Trendelenburg position) without disturbing the rectangularity of the frame and the cross section of the spars. By raising or lowering the surgical table or the adjustment column the proximal pivot member allows the second end of the frame to pivot relative to the surgical table, the floor, and the accessory base.

The rotatable head may be attached to the upper surface of the adjustment column at one end and attached to the multi-axis joint at the other end. The multi-axis joint can be attached to a yoke at the distal end of the yoke or at its second clevis end. The yoke at its proximal end or its first clevis end can be attached to the distal pivot member or in some embodiment distal pivot bolts. The distal pivot bolts or distal pivot member are in turn coupled to first end of the frame. The adjustment column may be extendable from the support column in which it is housed or nested to increase the elevation of the first end of the frame relative to the base. The adjustment column to which the frame is coupled may be retractable within the support column in which it is housed to decrease the elevation of the first end of the frame relative to the base. The adjustment column may have electric linear actuators housed inside it which may be used to raise and lower the extension column or extend it upwards from the support column in which it is housed. The accessory may further comprise a set of castors coupled to the base which has a support column extending upward and away from it. The castors may be spaced from a floor when the base is in a normal use position while the castors may engage the floor allowing the base and associated frame to be moved for transport in one embodiment. In other embodiments, the castors may have a spring actuator and lock pedal. When engaged the castors are locked into place. In other embodiments, when the lock pedal is engaged the castors spring up and away from the accessory base and the base settles onto the floor thereby stabilizing the accessory. A handle may be coupled to the upper region of the support column. In other embodiments, a handle may be coupled to the upper region of the adjustment column. The handle may be grippable to push the wheeled base to move it to a desired location or alternatively, it may be used to pull the accessory into the desired position. The handle may comprise a horizontal bar having gripping portions on the side opposite its attachment point to the accessory.

Also, according to this disclosure, an accessory may comprise a frame, a base which is supportable on a floor during surgery and a support column extending upwardly from the base. The support column may have a housing in which one or more adjustment columns may reside and to which they are coupled. The adjustment column may also act as a second support column for the accessory. The support column may have linear actuators coupled to the adjustment columns that, when operable, may drive the adjustment columns upwards and away from the base or alternatively the linear actuator may draw the adjustment column into the support column and downward relative to the base, thereby changing the effective height of the support column.

A panel that may be coupled to the spars may also be provided. Ends of the panels may be supported on the support members or the spars or the pivot members such that the panels span across a space defined between the frame members. At least one end of the panel may have a notch in it through which a portion of one of the frame members is exposed. A first side of a spar clamp may couple to a portion of one of the frame members or spars exposed in the notch. A second side of the spar clamp may have an accessory rail attached to it. A second clamp may couple to the accessory rail. The second clamp may be removably coupled to an armboard or other accessories. A mattress or pad may be removably attached to the panel. The mattress may have a portion that overlies the notch and the first clamp when the mattress is attached to the panel.

Additional feature which alone or in combination with any other feature(s), such as those listed above and those listed in the appended claims may comprise patentable material and will be apparent to those skilled in the art after consideration of the following detailed description of illustrative embodiments that exemplify differing modes for carrying out the embodiments as presently conceived.

An accessory has a substantially rectilinear radiolucent frame with two spaced spars rectilinear in cross section, spaced support elements, a floor-supported column, adjustment columns housed in and extending out of the support column, and an electrical linear actuator attached to the adjustment column, a rotatable head with a top surface, a bottom surface, and a proximal horizontal surface. The adjustment column and rotatable head are coupled at the top surface of the adjustment column and the bottom surface of the rotatable head. The rotatable head may rotate around one axis of rotation. The rotatable head is attached to a swivel joint which has freedom of movement around three axes of rotation. The swivel joint in turn is attached to a yoke at its first end and with the second end of the yoke coupled to a first end of the frame via a distal pivot member. The distal pivot member allows the first end of the frame to pivot around one axis of rotation. A second end of the frame may be removably coupled via a proximal pivot member to the distal end of a surgical table which allows the second end of the frame to pivot around another axis of rotation. The frame including the rotatable head, the swivel joint and the proximal and distal pivot members have freedom of motion around at least six axes of rotation. These axes of rotation are shown in FIG. 1 and are referenced as axis A-A, axis B-B, axis C-C, axis D-D, axis E-E and axis F-F where one embodiment of the disclosure frame 122 is illustrated as well as surgical table 002 to which it is removably coupled. At least two axes of rotation of the frame can be simultaneously locked and unlocked against rotation while the axis of rotation E-E of the frame is able to be independently locked against rotation.

The frame is movable to a compact storage position with the second end of the frame supported on the base. The frame may have leg, chest, or hip supports (“patient support devices ”) removably attached to it. Patient support devices can be moved up and down the spars of the frame while in an unlocked position and held in position on the spars when in a locked position. The frame is designed in a manner whereby the patient support devices do not have to be removed when storing the accessory frame. A set of lockable castors are provided on the base of the accessory to permit it to be wheeled from one location to another and locked into place once in the desired location.

Another embodiment relates to an accessory for attachment to a surgical table that supports at least a portion of a patient's body, the accessory comprising at least one support structure having an adjustable length, a frame extending from a proximal end to a distal end, wherein the distal end of the frame is configured to be rotatably coupled to the surgical table, and a multi-axis joint mounted onto the at least one support structure rotatably coupled to the proximal end of the frame, wherein the multi-axis joint has at least a first rotational degree of freedom about a tilt axis of the frame and a second rotational degree of freedom about an axis orthogonal to the tilt axis of the frame.

In another embodiment of the accessory, the frame includes two spar members each extending from the proximal end to the distal end of the frame, and each spar member rotatably coupled at a distal end thereof to the surgical table.

In another embodiment, the accessory comprises a yoke configured to couple the multi-axis joint to the spar members, such that the multi-axis joint can allow concurrent rotations of the yoke about the tilt axis of the frame and the axis orthogonal to the tilt axis of the frame.

Another embodiment is directed to an accessory for attachment to a surgical table that supports at least a portion of a patient's body, the accessory comprising at least one support structure having an adjustable height, a frame extending from a proximal end to a distal end, wherein the distal end of the frame is configured to be rotatably coupled to the surgical table, a multi-axis joint mounted onto the at least one support structure, wherein the multi-axis joint has at least three rotational degrees of freedom, and a yoke having a proximal end that is coupled to a distal end of the multi-axis joint and a distal end that is rotatably coupled to the proximal end of the frame, wherein the coupling of the distal end of the multi-axis joint to the proximal end of the yoke allows for rotation of the yoke about the at least three rotational degrees of freedom, thereby allowing for rotation of the frame about the at least three rotational degrees of freedom.

In another embodiment, the accessory comprises a coupler that pivotably and removably couples the distal end of the frame to the surgical table such that the at least two spar members are able move in response to movement of the surgical table and/or movement of the at least one support structure.

In another embodiment, movement of the multi-axis joint about at least two of the at least three rotational degrees of freedom can be simultaneously locked and unlocked.

Another embodiment is directed to an accessory for attachment to a surgical table that supports at least a portion of a patient's body, the accessory comprising at least one support structure extending from a proximal end to a distal end, wherein the proximal end of the at least one support structure is movable along a longitudinal axis of the support structure so as to adjust a length of the at least one support structure, a frame comprising at least two spar members each extending from a proximal end to a distal end, wherein the distal end of each of the spar members is rotatably coupled to the surgical table, a multi-axis joint mounted to the proximal end of the support structure, a yoke rotatably coupled to the proximal end of one of the at least two spar members and rotatably coupled to the proximal end of another one of the at least two spar members such that the yoke is rotatable about an axis substantially orthogonal to a longitudinal axis of each of the spar members, wherein the multi-axis joint is coupled to the yoke and is configured to allow rotation of the yoke about an axis orthogonal to a tilt axis of the frame concurrently with rotation of the frame about the tilt axis.

In another embodiment, the accessory further comprises a platform fixedly coupled to the distal end of the at least one support structure.

In another embodiment, the at least one support structure has a telescopic beam.

In another embodiment, the frame can move about six axes of rotation.

In another embodiment, the accessory further comprises a rotatable locking head that couples the multi-axis joint to the support structure, wherein the rotatable locking head is rotatable about a longitudinal axis of the support structure.

In another embodiment, the rotatable locking head comprises a lever that is movable between a first position and a second position, wherein when the lever is in the first position, the rotatable locking head is rotatable, and when the lever is in the second position, the rotatable lockable head is locked against rotation.

In another embodiment, the surgical table allows the frame to move or articulate about six axes of rotation.

In another embodiment, the frame is a rectilinear frame comprising radiolucent members.

In another embodiment, the accessory further comprises a lockable rotatable head attached to a top surface of the support structure, the rotatable head being configured to rotate around a perpendicular axis to the floor and which runs down the center of the adjustment column and the support column and the floor, wherein a distal portion of a multi-axis joint is coupled.

In another embodiment, the accessory further comprises a lockable rotatable head attached to a top surface of the support structure, the rotatable head being configured to rotate around a perpendicular axis to the floor and which runs down the center of the adjustment column and the support column and the floor, wherein a distal portion of a multi-axis joint is coupled.

In another embodiment, the accessory further comprises a lockable rotatable head attached to a top surface of the support structure, the rotatable head being configured to rotate around a perpendicular axis to the floor and which runs down the center of the adjustment column and the support column and the floor, wherein a distal portion of a multi-axis joint is coupled.

In another embodiment, the multi-axis joint comprises a main clamp having a circular cutout formed therein, a rotational hub having a through hole formed therein, a yoke pivot member configured to be rotatably fit in the through hole, semisphericals configured to be placed around the circumference of the rotational hub and positioned within the circular cutout, wherein the yoke is rotationally coupled to the yoke pivot member to allow rotation of the yoke about the yoke pivot member.

In another embodiment, the multi-axis joint comprises a main clamp having a circular cutout formed therein, a rotational hub having a through hole formed therein, a yoke pivot member configured to be rotatably fit in the through hole, semisphericals configured to be placed around the circumference of the rotational hub and positioned within the circular cutout, wherein the yoke is rotationally coupled to the yoke pivot member to allow rotation of the yoke about the yoke pivot member.

In another embodiment, the multi-axis joint comprises a main clamp having a circular cutout formed therein, a rotational hub having a through hole formed therein, a yoke pivot member configured to be rotatably fit in the through hole, semisphericals configured to be placed around the circumference of the rotational hub and positioned within the circular cutout, wherein the yoke is rotationally coupled to the yoke pivot member to allow rotation of the yoke about the yoke pivot member.

Another embodiment is directed to an accessory for attachment to a surgical table that supports at least a portion of a patient's body, the accessory comprising a surgical table that allows the rectilinear frame to move or articulate about six axes of rotation, at least one support structure having an adjustable length, a frame extending from a proximal end to a distal end, wherein the distal end of the frame is configured to be rotatably coupled to the surgical table; and at least two or more joints mounted onto the at least one support structure rotatably coupled to the proximal end of the frame, wherein the at least two or more joints have at least a first rotational degree of freedom about a tilt axis of the frame and a second rotational degree of freedom about an axis orthogonal to the tilt axis of the frame.

Another embodiment is directed to a clamp configured to attach to a surgical accessory rail having an outer and inner side, the clamp comprising a clamp body having a table rail acceptance channel formed therein configured to receive the surgical accessory rail, and first and second holes formed in the clamp body, first and second threaded screws extending through the first and second holes, respectively, a first knob fitted onto the first threaded screw, wherein rotation of the first knob causes an end of the first threaded screw to impinge upon an outer side of the surgical accessory rail, thereby securing the clamp to the outer side of the surgical accessory rail, a rocker arm having a toe that extends from the rocker arm, and a second knob fitted onto the second threaded screw, wherein rotation of the second knob causes an end of the second threaded screw to impinge upon the rocker arm causing the rocker arm to tilt so that a surface of the toe impinges on an inner side of the surgical accessory rail, thereby securing the clamp to the inner side of the surgical accessory rail.

In another embodiment, a yoke may have a first and a second clevis end. The first end of the frame may be attached to a first clevis end. A second clovis end of the yoke may attached to a connector.

The connector may be attached by a first end of the clevis yoke to a series of joints that in turn connect to a pivot joint at a first end of a frame. In this embodiment the connector may be attached to the adjustment column. The connector may have a distal section and a proximal section with each section being generally perpendicular to one another.

The proximal connector section may be rotatable and be able to be locked against rotation. The frame may be pivotable and have at least two pivot joints at its distal end so that it pivots relative to the adjustment column, allowing the frame to be stored onto a base without adjusting the spars outwardly or inwardly relative to the connector.

In one embodiment, a gimbal may comprise a connector attached at its distal end to the upper region of the adjustment column, or in some embodiments at the top surface of the adjustment column, with the connector attached at its proximal end to a yoke with two clevis ends. A connector may comprise a distal connector section generally parallel to the adjustment column and a proximal connector section generally perpendicular to the adjustment column.

In this embodiment, the proximal connector section may be rotatable and lockable and is generally parallel to the floor. The distal connector section may be rotatable and lockable and is generally perpendicular to the floor. The connector may be circular or oval in cross section and may be constructed out of two or more sections of tube attached or fitted together.

Both connector sections may be formed of hollow tubes. A yoke may have opposing first, and second clevis ends. The proximal connector section may have a proximal cap fitted onto the front surface of its proximal end with the proximal cap having a slot in its distal end and a yoke support pivot member located in the slot. The slot may be generally parallel to the floor. The yoke pivot member may have a through hole formed midway along its length. The proximal cap of the proximal connector may have aligned holes formed into and through its top and bottom surfaces. A vertical pivot member may comprise a bolt with a capped end and with a threaded end plus a lug. The vertical pivot member may be placed through the hole into the top center proximal surface of the proximal cap and into and through a through hole located at the midpoint of the yoke pivot member and then into and through the hole formed in the bottom surface of the proximal cap and capped with the lug at its threaded end.

In one embodiment, spars at the first end of the frame may be attached to the first clevis end by a distal pivot member by the pivot member. The pivot member can be generally perpendicular to the spars. In other embodiments, the spars at the first end of the frame may be attached to yoke pivot member by two pivot members and the second clevis end may be attached to the yoke support pivot member. The first clevis end of the yoke may be attached to the distal pivot member which in turn is attached to a first end of the frame.

The proximal connector section may be rotatable up to 90 degrees and lockable. The distal connector section may be fitted into a hole formed in the top surface of the adjustment column. There may be a flange attached or formed into the circumference of the lower region of the distal connector section which fits against a collar located around or near the top of the hole in the upper surface of the adjustment column and affixed thereto. This flange-collar combination may allow distal connector section to rotate in the hole which may be lockable against rotation.

A second end of the frame may be removably attached to the distal end of a surgical table by a proximal pivot member.

In some embodiments, a gimbal comprises a yoke with two clevis ends, a rotatable proximal connector section, a rotatable distal connector section, a vertical pivot member coupled to the proximal connector section, a yoke pivot member coupled to the vertical pivot member and to a second clevis end of the yoke and the second clevis end of the yoke coupled to a distal pivot member.

The distal pivot member in this embodiment may be attached to a first end of the frame allowing the first end of the frame to pivot about the generally parallel axes of the yoke support pivot member and the distal pivot member when the adjustment column is raised and lowered and/or as the surgical table is raised and lowered.

The vertical pivot member may attach the yoke pivot member to the proximal connector section allowing the frame to move side to side in a plane generally horizontal to the floor.

The proximal connector section can be attached to the distal connector section which is generally perpendicular to the floor and generally perpendicular the proximal connector section.

The proximal connector section can be rotatable about and axis that is generally parallel to the floor and perpendicular to the distal connector section.

The distal connector section can be fitted into a hole formed in the top surface of the adjustment column and can be allowed to rotate around an axis running through the center of the adjustment column and which is generally perpendicular to the floor. The rotation of the distal connector section allows the frame to move side to side in a plane generally parallel to the floor.

In this embodiment, the gimbal allows rotational motion about at least five axes. The attachment of the second end of the frame to the distal end of a surgical table by the proximal pivot member may further allow pivoting of the frame about the lateral and longitudinal axes of the spars extending from the support column. This pivoting around the axis of the proximal pivot member may occur because of the operation of linear actuators in the surgical table raising or lowering it or because of the operation of linear actuators in the support column raising and lowering the adjustment column.

In this embodiment, the gimbal allows the first end of frame to move side to side in a plane parallel to the floor as the surgical table articulates through its ranges of motion. Specifically, the vertical pivot member allows the yoke to which it is indirectly attached and the frame to which the yoke is further attached to move side to side in a plane parallel to the floor as the surgical table is tilted at an angle to the floor and as the head section is lowered and the foot section is raised (the “Trendelenburg” position) without disturbing the rectangularity of the frame and the cross section of the spars.

In one embodiment, the adjustment column is attached to the connector at its distal end. The proximal end of the connector is attached to a yoke at the distal end of the yoke. The yoke at its proximal end is attached to the distal pivot member which is coupled to first end of the frame. The adjustment column may be extendable from the support column in which it is housed or nested inside the support column to increase the elevation of the first end of the frame relative to the base. The adjustment column to which the frame is coupled may be retractable to within the support column in which it is housed to decrease the elevation of the first end of the frame relative to the base. The adjustment column may have electric linear actuators housed inside it which may be used to raise and lower the extension column.

In some embodiments, the gimbal may also be attached to the first end of the frame with a proximal pivot member attached to a second end of the frame. The proximal pivot member may be removably coupled to the distal end of the surgical table. The gimbal and proximal pivot member may be configured to permit movement of the accessory around up to six axes of rotation due to movement of the adjustment column and or the articulation of the surgical table.

In some embodiments, the gimbal may include a connector with a rotatable distal connector section that is attached to the upper region of the adjustment column and a rotatable proximal connector section attached to the first end clevis end of yoke with two opposing clevis ends.

Furthermore, the gimbal may comprise a connector formed out of a hollow tube in some embodiments. The connector may be formed or made from metal or a hard polymer or a combination of these or other suitable materials. The connector may also be formed or molded as a monolith or may be comprised of two or more hollow tubes or hollow semi-tubes fitted together. The connector may have a distal section that is generally parallel to the extension column and generally perpendicular to the floor along with a proximal section being generally perpendicular to the adjustment column and generally parallel to the floor with the two connector sections forming an “L” shaped connector.

The proximal connector section comprising part of the gimbal may be generally parallel to the floor while being generally perpendicular to the support column, the adjustment column and the distal connector section. The proximal connector section may be rotatable relative to the distal connector section. The proximal connector section may be locked into place to stop any further rotation relative to the accessory by use of a brake attached to the distal end of a handle. This brake handle may be fitted into a hole in the distal connector section and its distal end may impinge upon gear like features formed in the distal region of the proximal connector section. The proximal connector section may have a proximal cap attached to its end or formed into its proximal end. In some embodiments, the proximal cap may be hemispherical in shape while the distal end of the proximal connector section may be a hollow tube and so sized so that the proximal cap fits snuggly over, and may be attached to, the proximal end of the proximal connector section. The front surface of the proximal cap may have a generally horizontal slot formed unto it with the slot being generally parallel to the floor and the accessory base while being generally perpendicular to the adjustment column. Coaxial holes may be formed into and through the center of the top surface and a center of the bottom surface of the connector cap.

In some embodiments, a yoke pivot member may comprise a bolt threaded at both ends which may have a through hole formed at a point midway along its length. There may be a vertical pivot member comprising a bolt with a cap at one end and threaded at the other end and a lug to cap the threaded end. The yoke pivot support member may be secured onto the connector cap by placing the vertical pivot member into and through the coaxial hole in the top surface of the connector cap, into and through a hole formed midway along the length of the yoke pivot member and into and through the coaxial hole formed in the bottom surface of the connector cap. The vertical pivot member can then be secured in place by attaching and tightening the lug around its threaded end. The vertical pivot member allows rotational motion of the yoke and the attached frame around the member in a plane generally horizontal to the floor and the accessory base.

In other embodiments, coaxial holes are formed in the proximal upper and bottom surface of the proximal connector section which has a slot formed into its proximal front surface with the slot being generally parallel to the floor and the accessory base.

In one embodiment, a yoke maybe formed of metal or carbon fiber or other suitable materials. The yoke may comprise two opposing clevis ends including a first clevis end and a second clevis end. The forks of the second clevis end may be spaced to fit around or nestle close to the outside surface of the connector cap or the distal region of the proximal connector section. The second clevis end of the yoke may have holes formed in it sized to accept each end of yoke pivot member. The yoke pivot member may comprise a bolt with threaded ends in some embodiments. The yoke pivot member may be placed through the holes of the second clevis end while threaded nuts may be engaged onto the threaded ends of the yoke pivot member to couple it to the second clevis end. The first clevis end may have holes formed into its end region. The forks of the second clevis end may be spaced so that its outside surface fits closely to the inside surface of the distal region of the spars. The first end of the frame may comprise the distal region of the two spars and a distal pivot support member which connects the spars. The distal region of the spars may have a through hole formed through them. A proximal coupler with a rectilinear cross section may have a channel form into it to accept the spar so the coupler fits snuggly over the spar. The proximal coupler may have coaxial through holes formed into its lateral and medial surfaces. The distal pivot support member may be generally perpendicular to the spars and have threaded ends. The threaded ends of the distal support pivot member can be fitted into and through the holes in the proximal clevis end of the yoke and then into and through corresponding holes located in the distal coupler and into and through holes formed in the distal region of the side surfaces of the spars. The Lug nuts can be applied to each threaded end of the distal pivot member securing the proximal clevis end of the yoke, the distal pivot member and the two spars together and forming one joint of the gimbal.

A yoke formed of metal hard plastic polymers or carbon fiber or a combination of two or more such materials may comprise two opposing clevis ends with one being a first clevis end and the other being a proximal end. In one embodiment, the distal clevis end may be sized to fit to the outside surface of the proximal cap of the proximal connector section and aligned with the slot formed in the proximal cap that is generally horizontal to the floor and the accessory base. In other embodiments, the second clevis end of the yoke may be sized to fit to the outside surface of the distal region of the proximal connector section and aligned with a portion of a slot formed in the front surface of the proximal connector section that is generally horizontal to the floor and accessory base.

The first end of the frame may include a distal pivot member that spans between the two spars and is coupled to the second clevis end of the yoke and the two spars. The yoke has a first clevis end which can be attached to a yoke support pivot member. The yoke support pivot member in turn can be attached to the vertical pivot member. The vertical pivot member can be connected to the proximal connector section. The proximal connector section can be attached to the distal connector section via a through hole sized to accept the proximal section. A flange on the distal end of the proximal connector section that fits around and is bolted to its distal end securing it to the distal connector section but leaving it free rotate can be used. A brake handle that can be fitted into a hole in the rear upper surface of the distal connector section. The distal end of the brake handle may interface with gear like features formed into the outer circumference of the distal region of the distal connector section. When engaged in the gear like cut outs, the brake handle can lock the proximal connector section against rotation. The proximal connector section is generally parallel to the floor while the distal connector section is generally perpendicular to the floor.

An anti-rotation handle may be fitted into a hole in the back surface of the adjustment column with the distal end of the handle able to interface with the anti-rotation features of the distal connector section to lock it against rotation. When the handle is disengaged, the distal end no longer interfaces with the anti-rotation feature of the distal connector section allowing the distal connector section to rotate.

### BRIEF DESCRIPTION OF THE DRAWINGS

FIG. 1 provides a perspective view of one embodiment of the invention including certain details of the invention and the axes of rotation about which a frame may move.

FIG. 2 provides a perspective view of a distal portion of another embodiment of the invention.

FIG. 3A provides an exploded view of some aspects of portion of at least embodiment the invention including portions of a rotational head and a main clamp comprising a portion of the multi-axis joint.

FIG. 3B provides a perspective view of some aspects of the frame including an exploded view of some elements of the rotatable head, the frame, the patient support devices attached to the spars of the frame and the surgical table.

FIG. 4 provides an exploded view of a multi-axis joint.

FIG. 4A provides an exploded view of some elements of the distal end of the frame.

FIG. 4B illustrates some aspects of the distal portion of the frame.

FIG. 4C provides a perspective and exploded view of some elements of the frame.

FIG. 5 provides a perspective view and some details of the proximal end of at least one embodiment of the invention.

FIG. 6 illustrates some aspects of at least one embodiment of the invention including the proximal pivot member and the proximal clamp.

FIG. 7 illustrates a side view of a portion of at least one embodiment of the invention including the proximal clamp.

FIG. 8 provides a top section view of some aspects of at least one embodiment of the invention including the proximal clamp.

FIG. 9 provides a top sectional view of some aspects of the proximal clamp.

FIG. 10 provides a sectional view of some aspects of the patient support devices of the accessory.

FIG. 11 provides a perspective and exploded view of the proximal portion of at least one embodiment of the invention.

FIG. 12 provides a sectional view of the proximal portion of at least one embodiment of invention.

FIG. 13 provides cutaway perspective view of some components of the proximal pivot members.

FIG. 14 provides a sectional view looking towards the distal end and base of the invention.

### DETAILED DESCRIPTION

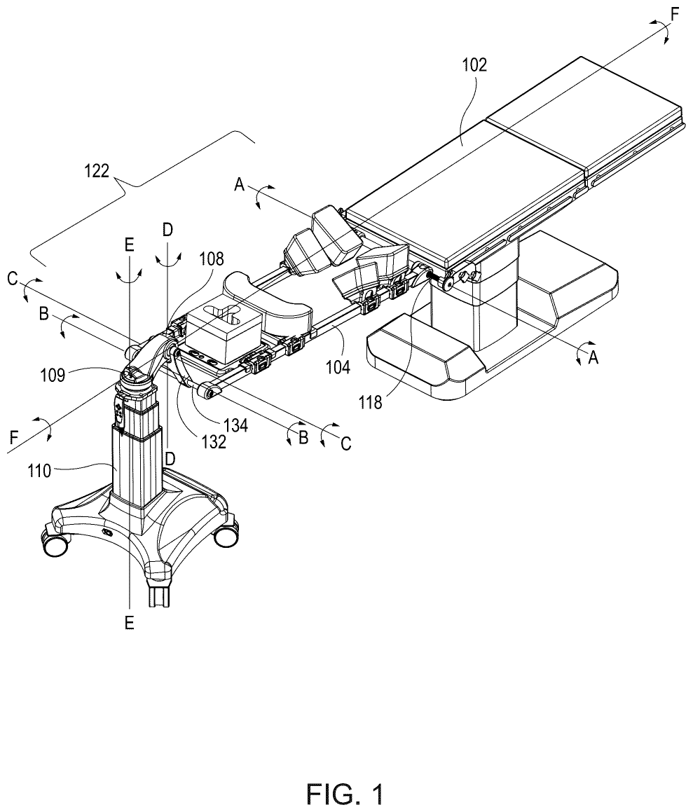

FIG. 1 is a perspective view of one embodiment of the invention, including six axes of rotation around which a frame may move. As shown in FIG. 1, the accessory has a wheeled storage base 3, a telescopic support structure 110 extending away from the base and coupled to a first end of a multi-axis joint 108 which in turn is coupled at its second end to a frame 122 having a first end and having a second end removably attached to a surgical table 102. Frame 122 has spars 104 coupled by distal pivot member 134 and proximate pivot member 118. Proximal pivot member 118 is removably coupled to distal end of surgical table 102. Distal pivot member 134 connects yoke 132 to first end of frame 122. Multi-axis joint 108 allows rotation about three axes C, D and G (parallel to spar). Rotatable head 109 allows rotation about an axis E that is generally perpendicular to the floor and parallel to a longitudinal axis of support structure 110. Yoke 132 comprises two opposing clevis ends that are coupled to the multi-axis joint 108, and two distal ends that are rotatably connected to the pivot member 134, thereby coupling multi-axis joint 108 to a first end of frame 122. Axes of rotation about which frame 122 may articulate are shown by reference in FIG. 1 and can include the following six axes of rotation:
Axis A-A in which the frame 122 rotates around the proximal pivot member 118 with the axis being generally parallel to the floor and axis of rotation B-B;
Axis B-B in which the frame rotates around the distal pivot member 134 which is generally parallel to the floor and generally parallel to the axis of rotation A-A; and,
Axis C-C which bifurcates the multi-axis joint 108;
Axis D-D which bifurcates the multi-axis joint 108;
Axis E-E which bifurcates rotatable head 109 and support structure 110 and is generally perpendicular to axes of rotation A-A and B-B;
Axis F-F which bifurcates the multi axis joint 108 and is generally perpendicular to the floor and runs generally along the midpoint of the surgical table and is generally perpendicular to the other axes or rotation.

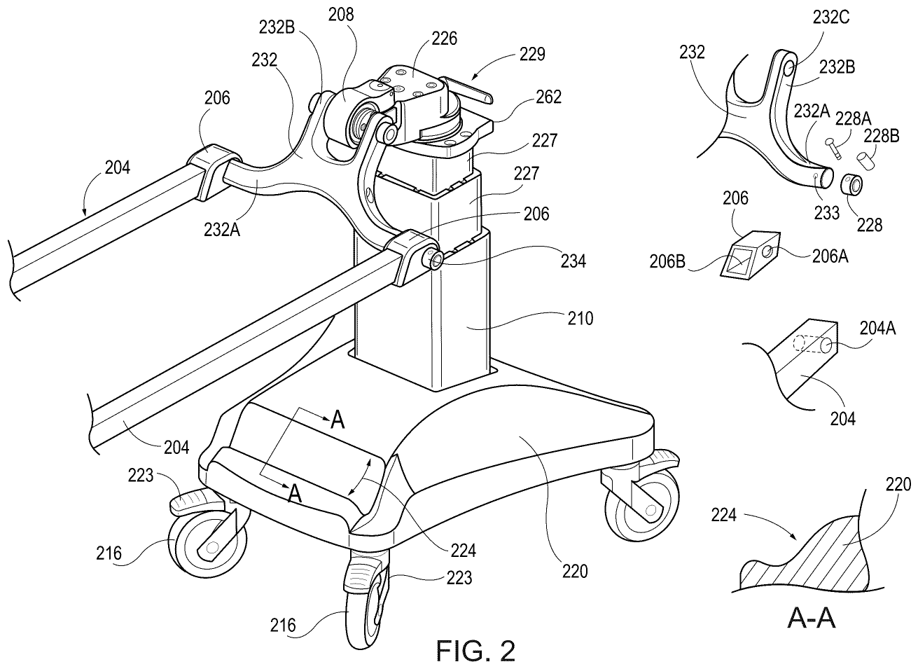

FIG. 2 illustrate some aspects of a portion of one embodiment of the accessory including two generally parallel spars 204, a floor mounted base 220 with castors 216 and castor locks 223. Trough 224 is formed into the top surface of the floor supported base 220 as shown in sectional view A-A. Support column 210 is fitted into top surface of floor mounted base 220. An extendable vertical support is attached to the base 220. The extendable vertical support includes support column 210 and at least one adjustment column 227 nested into the support column 210 that are used to extend the height of the extendable vertical support. Two, three or more adjustment columns can be used. Linear actuators (not shown) can be fitted into the inside of support column 210 and attached (not shown) to adjustment column 227 allowing the adjustment columns to be extended upwards and away from base 220 or lowered or retracted into the support column 210. Mount plate 262 is mounted to internal mount collar (not shown) which is fitted onto the underside (not shown) of top surface of adjustment column 227. Lock handle 229 is fitted into the distal horizontal surface of rotatable lockable head 226. Multi-axis joint 208 can be fitted into a recess formed in proximal horizontal surface of lockable head 226 and coupled thereto. Yoke 232 has second clevis end 232B with through hole 232C and first clevis end 232A with through hole 233 formed in each of its ends. Through hole 233 is sized to accept threaded bolt 228A. Distal mount cap 206 can have through hole 206A through its lateral and medial surfaces. In some embodiments, distal mount cap 206 may have spar acceptance channel 206B formed therethrough and sized to accept spar 204. Distal region of spar 204 may be fitted into acceptance channel 206B. Spar 204 may have though hole 204A formed into and through the sides in its distal region. Distal mount cap 206 may be fitted or slid over distal region of spar 204 so that holes 206A and holes 204A align. First clevis end 232A of yoke 232 may be fitted into and through hole 206A in distal mount cap 206 and hole 204A in spar 204. Yoke collar 228 may then be slid over the portion of first clevis end 232A of yoke 232 that protrudes from the lateral side of distal mount cap 206. Yoke pin 228A can be threaded at one end and may be slid through hole 233 formed in and through first clevis end 232A of yoke 232. Lug 228B may be then attached to threaded end of yoke pin 228A thus securing first clevis end 232A of yoke 232 to spar 204.

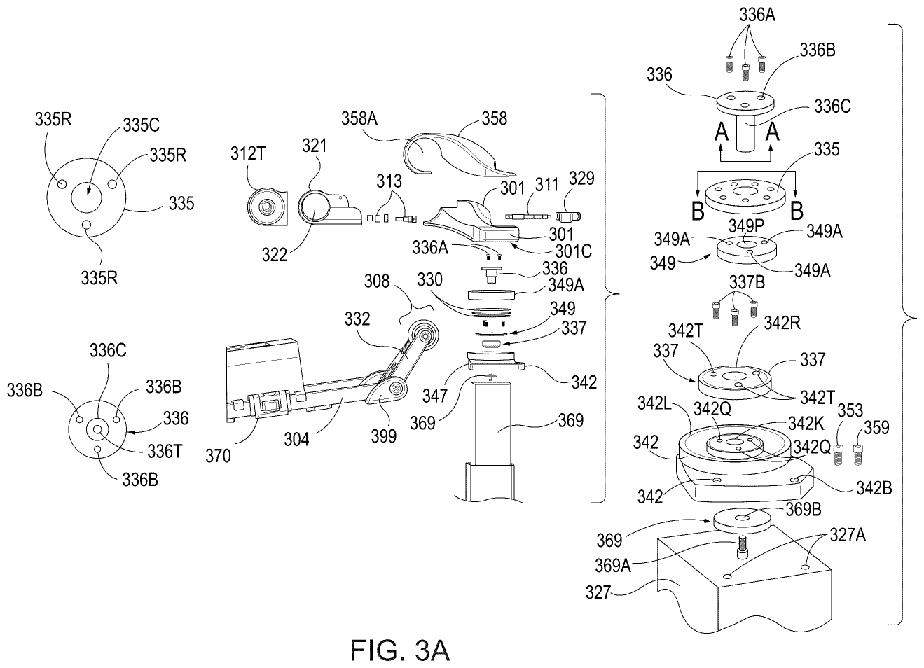

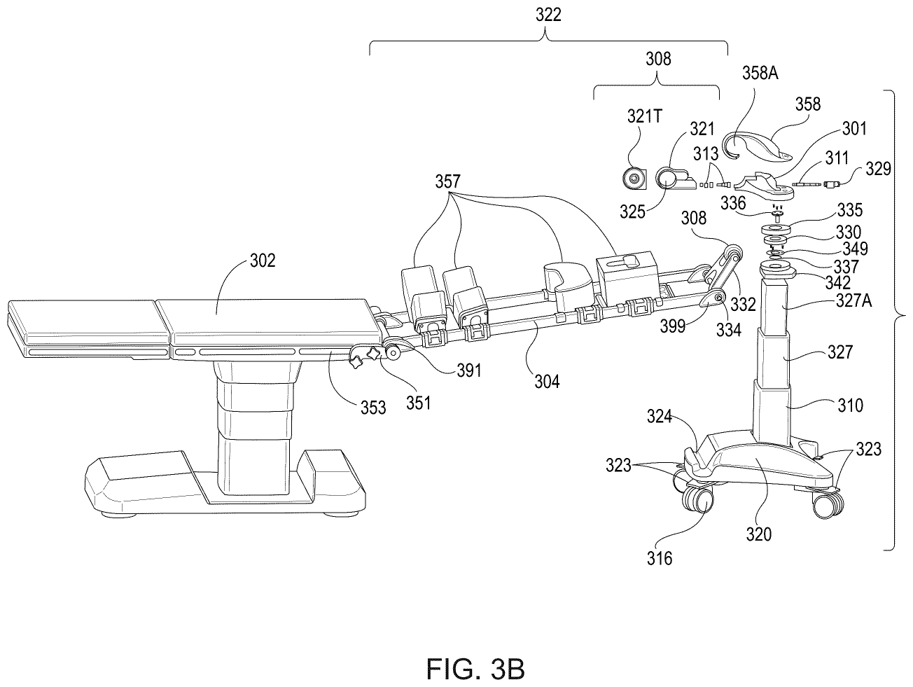

FIG. 3A illustrates certain aspects of one embodiment of the disclosure namely the rotatable head and other details of the distal end of frame 322 (see FIG. 3B). Mount plate 342 has through holes 342B formed into and through its top surface and threaded holes 342Q formed into its top surface. The top surface of adjustment column 327 has threaded holes 327A formed into its top surface. Threaded bolts 359 can be passed into and through holes 342B in top surface of mount plate 342 and screwed into thread holes 327A in top surface of adjustment column 327 securing the mount plate 342 to the adjustment column 327. In this embodiment, mount plate 342 can have securement ring 342L which mates with bottom distal surface 301C of top head plate 301. Puck 337 has through holes 342T formed around its through hole 342R formed through it center. Puck 337 may be secured to mount plate 342 by passing threaded bolts 337B through holes 342T and into threaded holes 342Q of the mount plate 342. Bearing aligner 336 has through holes formed through its upper plate while the bottom of bearing alignment post 336C has a threaded hole 336T formed into the center bottom surface of its end as shown in bottom view A-A. Coupling ring 349 has center through hole 349P formed in its center and through holes 349A formed around the center through hole 349P. Top plate 335 has through holes 335R formed around its outer circumference and hole 335C formed into and through its center as shown in top view B-B.

Ring bearings 330 can be sandwiched between coupling ring 349 and top plate 335. Puck 337 can be coupled with mount plate 342 by passing bolts 337B into through holes 342T and screwed into threaded holes 342Q. Bolts 336A can be placed into and through holes 336B of bearing aligner 336 and into and through holes 335R of top plate 335 and into and through holes 349A of puck 349. Bearing alignment post 336C of bearing aligner 336 can be passed into and through center through hole 335C of top plate 335, then into and through hole 349P of puck 349 and into and through center through hole 342R of puck 337. Bottom plate 369 with through hole 369B formed into and through its center can be placed around the portion of bearing alignment post 336C protruding out hole 342K in bottom surface of mount plate 342. Hole 369B formed in the center of bottom plate 369 is smaller than the cap of threaded bolt 369A. Threaded bolt 369 can then be fit into threaded hole (not shown) formed in the bottom surface of bearing alignment post 336C.

Cover 358 with circular portion 358A can be fitted onto top head plate 301. Flexible cover 321T can be placed over main clamp 321 with circular cut out 325 when the main clamp 321 is assembled. Actuation handle 329 can be coupled to distal end of cam 311 while cam blocks 313 can be coupled to proximal end of cam 311.

Yoke 332 is coupled to multi-axis joint 308 at its upper end and to distal pivot joint (not shown) at it lower end. Distal pivot joint (not shown) is attached to proximal spar coupler 399. Proximal spar coupler 399 has channels (not shown) size to accept spars 304 and the spars may be fitted into the coupler using the channels. Patient support devices 370 may be fitted onto spars 304.

FIG. 3B shows another aspect of one embodiment of the invention including and exploded view of the rotatable head 326 and multi-axis joint 308 and a perspective view of spars 304 with patient support devices 357 attached to the spars. Frame 322 can be attached to the surgical table 302 via proximal pivot member 391 which is removably coupled to a proximal clamp which in turn is removable coupled to accessory rails 342 or surgical table 302. Spars 304 are attached to proximal spar cap 391 and distal spar cap 399 with proximal pivot joint 351 attached to the proximal spar cap 391 and distal pivot members 334 attached to the distal spar cap 399. Yoke 332 is coupled to distal pivot members 334 at its lower end and to multi-axis joint 308 at its upper end.

An exploded view of some components of the multi-axis joint 308 are also shown including main clamp 321 with circular cut out 325 and flexible cover 321T. Cam 311 has handle 329 and cam block 311 to which it may be coupled. When the cam is in a second position, the multi-axis joint is then locked against its motion and simultaneously prevents motion of the frame in at least two axes. Up to two of the axes of rotation may be locked against rotation by placing the cam of the multi-axis joint in the second position. Cover 358 with circular portion 358A may be placed over top head plate 301. Components of rotating head 326 include top plate 301, bearing aligner 336, top plate 335, ring bearings 330, coupling ring 349, puck 337 and mount plate 342. Base 323 with storage trough 324 formed in its proximal front surface has castors 316 with locks 323. The storage trough 324 can be shaped so that it can support the proximal end of the frame 322 when the frame is moved into a vertical storage position, thereby placing the accessory in a compact storage position with the frame supported on the base 320. Support column 310 is formed into top surface of base 320. Adjustment columns 327 and 327A extend upwards and away from support column 310, thereby forming a vertical support having an adjustable height.

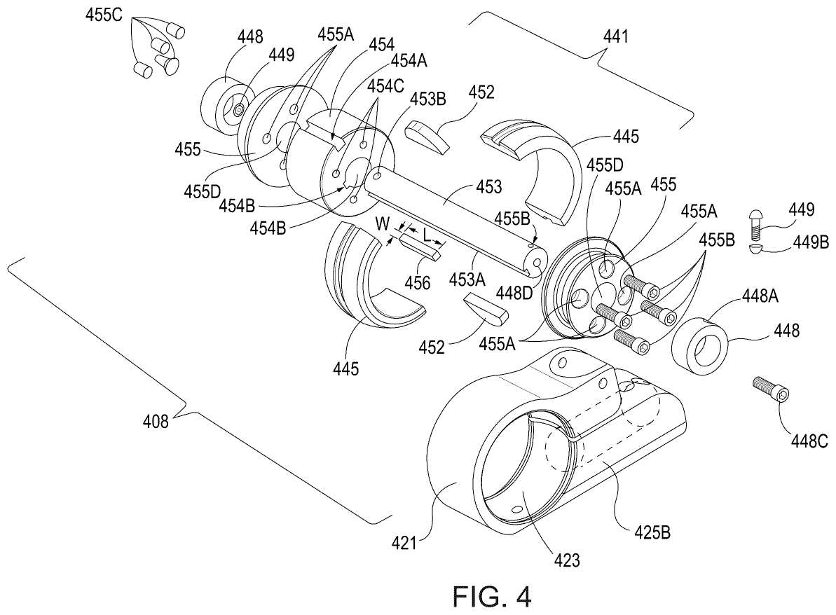

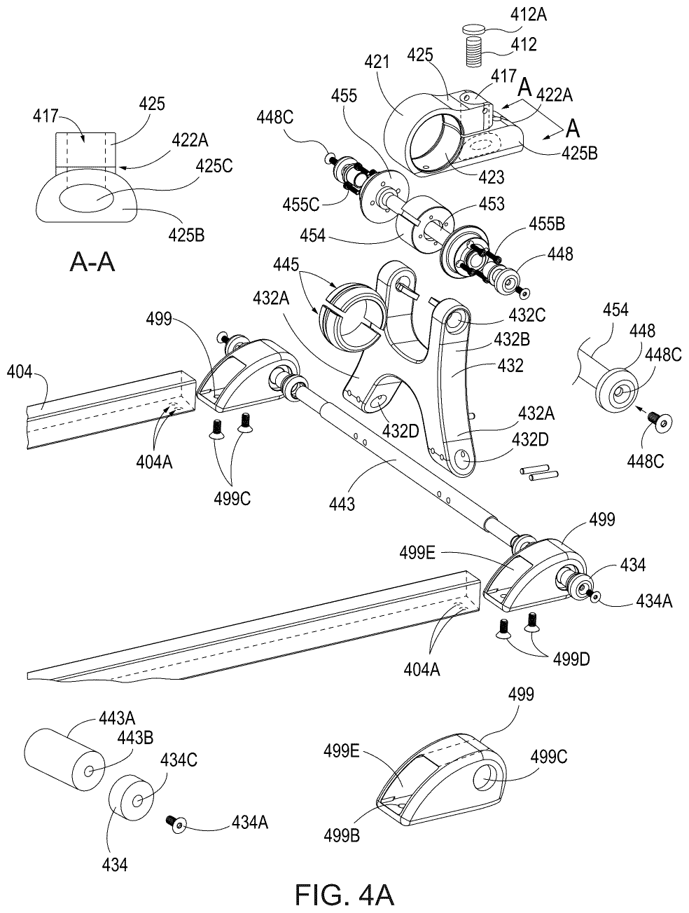

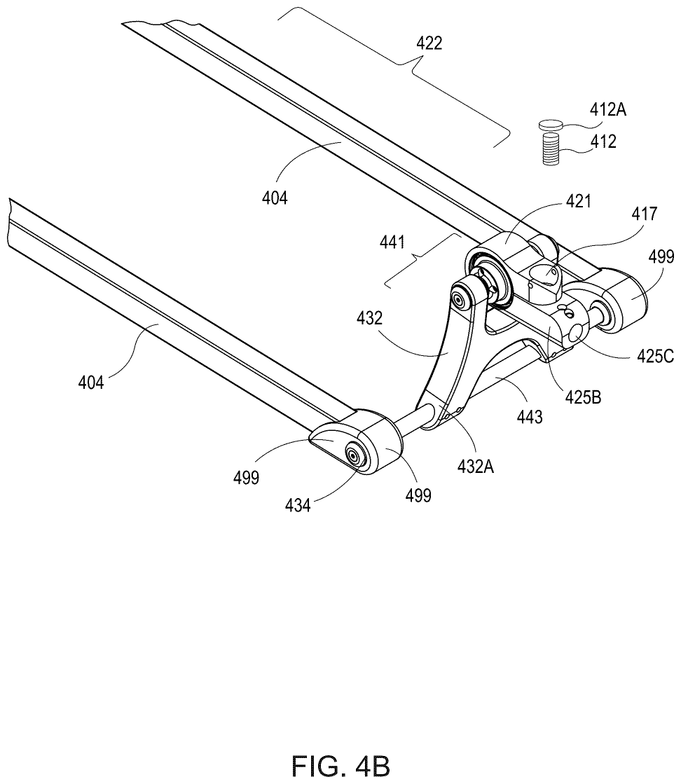

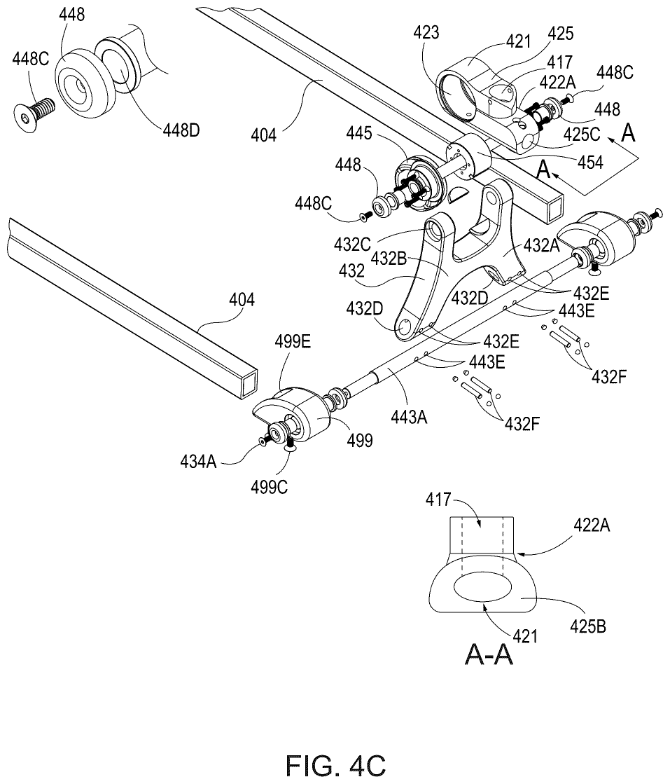

FIG. 4. shows a perspective view of an aspect of the invention, namely the multi-axis joint 408. Multi-axis joint subassembly 441 has yoke pivot member 453 with horizontal cut/slot 453A formed in its circumference and running its length and sized to accommodate the full length of capture element 456 and half of the width of the capture element. Yoke pivot member 453 has through holes 453B at each of its ends. Rotational hub 454 has through hole 454B formed into and though its center and sized to accept yoke pivot member 453. Through hole 454B has acceptance cut out 454C formed into its inner circumference and running along the inner surface of the through hole 454B. Rotational hub 454 has woodruff key cutouts 454A designed to accept woodruff keys 452. Capture element 456 is sized to fit into the entire length L of cutout 454C with half its width W captured therein and half of its width W protruding the length of the cut out. Semisphericals 445 are placed around rotation hub 454. The semisphericals 445 can be made of cast iron, aluminum, or any other similar metal. Yoke pivot member 453 is placed through through hole 454B in rotational hub 454 along with capture element 456 placed in slot 453A and with woodruff keys 452 placed in woodruff key cutout 454A. The semisphericals 445 are then nested around the external curved surface of rotational hub 454 and are placed inside circular cut out 423 of main clamp 421. Cover plates 455 have through holes 455A formed through it. Cover plates 455 are placed on the external surface of rotational hub 454. Holes 455A match up with through holes 454C in rotational Hub 454. Bolts 455B capped at one end and threaded at the other are placed in and through holes 455A in one cover plate 455 then and in and through through holes 454C in rotational hub 454 and in and through holes 455A in the opposing cover plate and then the bolts 455B are secured by lugs 455C. Yoke pivot member 453 may be slid into and through through hole 455D in a first cover plate 455, then through through hole 454B formed in and through the surface of rotational element 454 so that horizontal slot 453A in the pivot member 453 captures the width of capture element 456. Yoke pivot member 453 may be pushed through the lateral surface of a second capture plate 455. The ends of yoke pivot member 453 protrude out of the external surfaces of the first and second capture plates 455. Collar 448 has a through hole 448A formed in its circumference and is placed around each protruding end of yoke pivot member 453. Threaded bolt 449 capped at one end may be placed into and through through hole 448 and secured into place by lug 449B. Placement of collar 448 secured by threaded bolt 449 around yoke pivot member 453 secures semisphericals 445 into circular cutout 423 of main clamp 421.

FIG. 4A shows another embodiment of the disclosure including yoke 432 having first clevis end 432A and second clevis end 432B. Through holes 432D and 432C are formed in the tangs of first clevis end 432A and second clevis end 432B, respectively. Main clamp 421 has circular cut out 423 formed therein with slot 422A formed in a portion of its distal circumference. Slot 422A separates upper clamp housing 425 from lower clamp housing 425A. Section A-A shows a side view of the distal side of main clamp 421 where slot 422A separates upper clamp housing 425 from lower clamp housing 425B. Channel 425C is formed from the distal surface of lower clamp housing 425A and runs most of the length of the lower clamp housing. Through hole 417 is formed in the top surface of upper clamp housing 425 and extends into and through the upper clamp housing and into and through upper surface of lower clamp housing 425A where it intersects channel 425C. Bevel stack washer or spring stack washers 412 can be inserted into through hole 417 such that a portion thereof protrudes into channel 425C and is capped and held in place by cap 412A. Semisphericals 445 are sized so that their inner circumference fits snuggly around the outer circumference of rotational hub 454. The outer circumference of semi-sphericals 445 is sized to fit snuggly against the inner surface of circular cut out 423 of main clamp 421. Rotational hub 454 with semisphericals 445 fitted around its outer circumference may be placed into circular cut out 423 of main clamp 421. Rotation hub 454 has a hole formed into its center. Yoke pivot member 453 can be slid into and through hole 432C in second clevis end 432B of yoke 432. Yoke pivot member 453 can then be slid through the hole 454B in center of rotational hub 454 as it rests inside circular cut out 423 of main clamp 421. Further, the other end of yoke pivot member 453 can be slid through hole 432C formed in tang of second clevis end 432B of yoke 432. Cover plates 455 can be fitted onto each side of rotation hub 454 (see FIG. 4). Threaded bolts 455B can be fitted into and through matching holes in cover plate 455 and into and through holes in the side of rotational hub 454 (See FIG. 4) and out where they are capped by lugs 455C (See FIG. 4). Yoke pivot member 453 has threaded hole 448D formed in each end and threaded bolt with cap 448C can be screwed into the threaded holes. Distal pivot member 443 can be fitted through through hole 499C in distal spar cap 499 with channel 499E formed in its proximal surface. Channel 499E is sized to accept spar 404 and has through holes 499B formed into and through its bottom surface. Distal pivot member 443 can be slid through holes 499C in distal spar cap 499 and into and through holes 432D formed in tang of first clevis end 432A of yoke 432. Distal pivot member 443 can be further slid into and through hole 499C in far distal spar cap 499. Threaded hole 443B is formed in the ends of distal pivot member 443. Collar 434 has hole 434C formed into its center. Threaded bolt 434A can be slid through hole 434C in collar 434 and screwed into threaded hole 443B formed in the end of distal pivot member 443 securing the distal pivot member to distal spar cap 499. Distal spar cap 499 has channel 499E formed into its proximal surface sized to accept spars 404. Channel 449E has through holes 499B formed through its bottom surface that correspond to and match the spacing of threaded holes 404A formed into the bottom surface of spar 404. Spar 404 can be fitted into channel 499E of distal spar cap 499. Threaded bolts 499D can passed through through holes 499B in bottom surface of distal spar cap 499 and screwed into threaded holes 404A securing spars 404 to the distal spar cap.

FIG. 4B illustrates some aspects of at least one embodiment of the disclosure including multi-axis joint 441 with main clamp 421 with hole 417 formed therein into which bevel stack or disc spring washer 412 can be inserted and covered with cap 412A. Channel 425C is formed in the distal surface of clamp housing 425B and runs most of the length of the clamp housing. Yoke 432 attaches multi-axis joint 441 to distal pivot member 443. Distal pivot member 443 is fitted into and through through holes (not shown) in match distal spar caps 499. Distal spar cap 499 has channel (not shown) that allows spar 404 to be fitted into the channel, thus attaching the spars of frame 422 to yoke 432.

FIG. 4C provides a view of some aspects of at least one embodiment of the disclosure including yoke 432 having first clevis end 432A and second clevis end 432B. Through holes 432D and 432C are formed in the tangs of first clevis end 432A and second clevis end 432B, respectively. Main clamp 421 has circular cut out 423 formed in it with slot 422A formed in a portion of its distal circumference. Slot 422A separates upper clamp housing 425 from lower clamp housing 425A. Section A-A shows a side view of the distal side of main clamp 421 where slot 422A separates upper clamp housing 425 from lower clamp housing 425A. Channel 425C is formed from the distal surface of lower clamp housing 425A and runs most of the length of the lower clamp housing. Through hole 417 is formed in the top surface of upper clamp housing 425 and extends into and through the upper clamp housing and into and through upper surface of lower clamp housing 425A where it intersects channel 425C. Semisphericals 445 are sized so that their inner circumference fits snuggly around the outer circumference of rotational hub 454. The outer circumference of semisphericals 445 is sized to fit snuggly against the inner surface of circular cut out 423 of main clamp 421. Rotational hub 454 with semisphericals 445 fitted around its outer circumference may be placed into circular cut out 423 of main clamp 421. Rotation hub 454 can have a hole formed into its center. Yoke pivot member 453 can be slid into and through hole 423C in second clevis end 432B of yoke 432. Yoke pivot member 453 can then be slid through the hole in center of rotational hub 454 as it rests inside circular cut out 423 of main clamp 421. Further, the other end of yoke pivot member 453 can be slid through hole 432C formed in tang of second clevis end 432B of yoke 432. Cover plates 455 can be fitted onto each side of rotation hub 454. Threaded bolts 455B can be fitted into and through matching holes in cover plate 455 and into and through holes 455A in the side of rotational hub 454 (see FIG. 4) where they are capped by lugs 455C (see FIG. 4). Yoke pivot member 454 has threaded hole 448D formed in each end and threaded bolt with cap 448C can be screwed into the threaded holes. Distal pivot member 443 can be fitted through through hole 499C in distal spar cap 499 with channel 499E formed in its proximal surface. Channel 499E is sized to accept spar 404 and has through holes 499B formed into and through its bottom surface. Distal pivot member 443 can be slid through holes 499C is distal spar cap 499 and into and through holes 432D formed in tang of first clevis end 432A of yoke 432. Distal pivot member 443 can be further slid into and through hole 499C in far distal spar cap 499. Threaded hole 443B is formed in the ends of distal pivot member 443. Collar 434 has hole 434C formed into its center. Threaded bolt 434A can be slid through hole 434C in collar 434 and screwed into threaded hole 443B formed in the end of distal pivot member 443 securing the distal pivot member to distal spar cap 499. Through holes 432D are formed into and through distal and proximal surface of first clevis end 432A of yoke 432. Matching through holes 443E are formed into and through distal pivot member 443. Bolts 432 threaded at both end are fitted through matching holes 432E in distal surface of second clevis end 432A and into and through through holes in distal pivot member 443 and capped by lugs thus securing the second clevis of the yoke to the distal pivot member.

As presented above, the combination of the rotational degrees freedom of the rotational head, the multi-axis joint and the yoke allows for the matching of the degrees of freedom of movement between the frame and the surgical table, thereby minimizing the torsion and bending forces experienced by the frame and its spar members during use. This can prevent the uncontrolled movement or even detachment of the patient support devices during surgical procedures while allowing easy storage of the accessory with minimal steps.

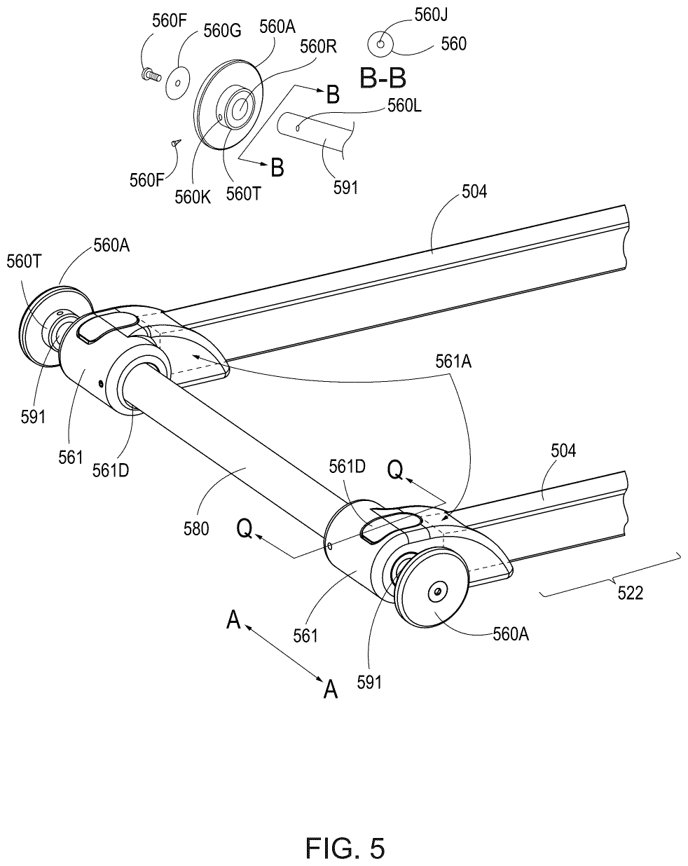

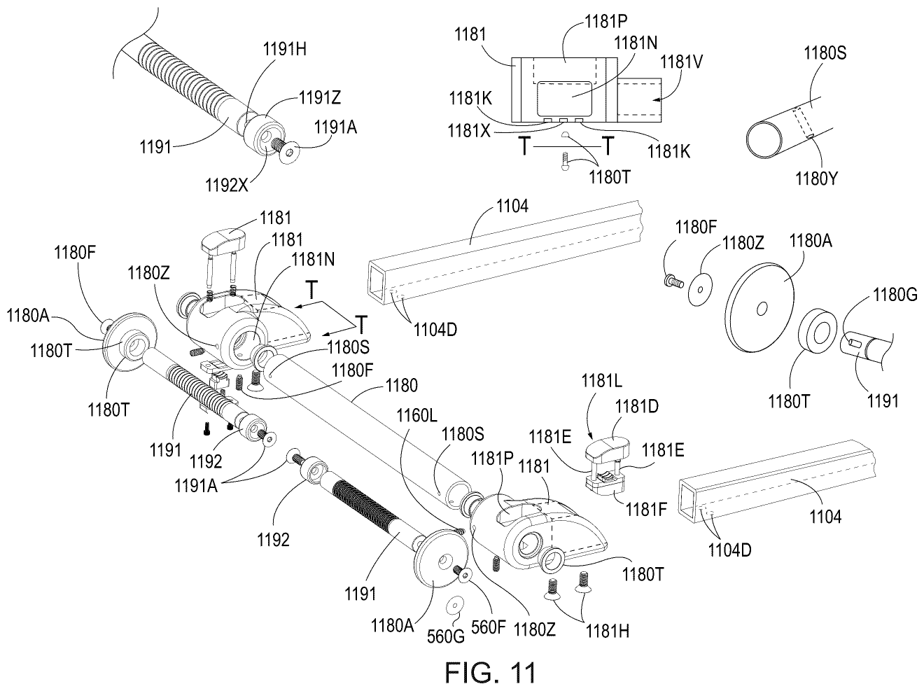

FIG. 5 provides details of an embodiment of the accessory including the proximal pivot member 591 which rests in proximal guard tube 580 and which removably connects second end of frame 522 to the distal end of surgical table (not shown). Proximal spar cap tube 561 has coaxial holes 561D formed through its lateral and medial side and also has channel 561A formed in its distal side sized to accept spars 504. Coaxial hole 561D is formed through the sides of proximal spar cap 561. Distal pivot member 560 has holes formed at the distal region of its end. Proximal coupler 561 can be slid over the proximal end region of spars 504. Proximal coupler 561 can have actuation button 561D that can be pressed to release and allow proximal pivot member 591 to be adjusted outward or inward in the direction of arrow A-A (see FIG. 11 for details). Proximal pivot member 591 can be slid into and through and then out of holes 561B formed through proximal spar cap 561 and into proximal guard tube 580. Catch plate 560A with hole 560R may be fitted over end of proximal pivot member 591 (See FIG. 11 for additional details). Plate 560G with hole in its center may be placed over hole 560R on outer side of catch plate 560A. Screw 560F can be passed through hole in plate 560G and threaded into threaded hole 560J formed into the end of proximal pivot member 591. Hole 560K in collar 560T formed on the inside surface of catch plate 560A can be lined up with hole 560K in proximal pivot member 591 and screw 560F inserted into the holes securing the proximal pivot member 591 to the catch plate 560A. FIG. 11 provides additional details of the proximal pivot member/proximal guard tube assembly.

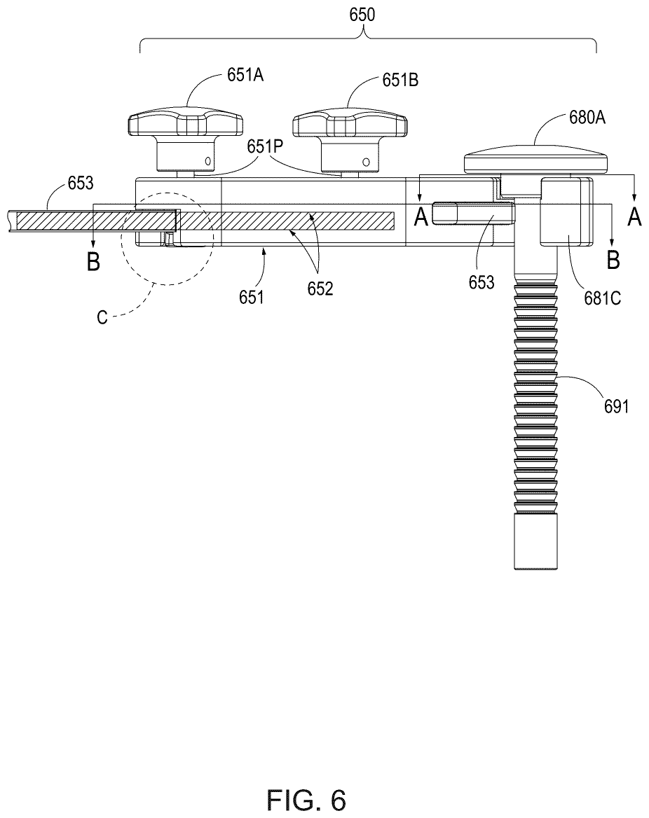

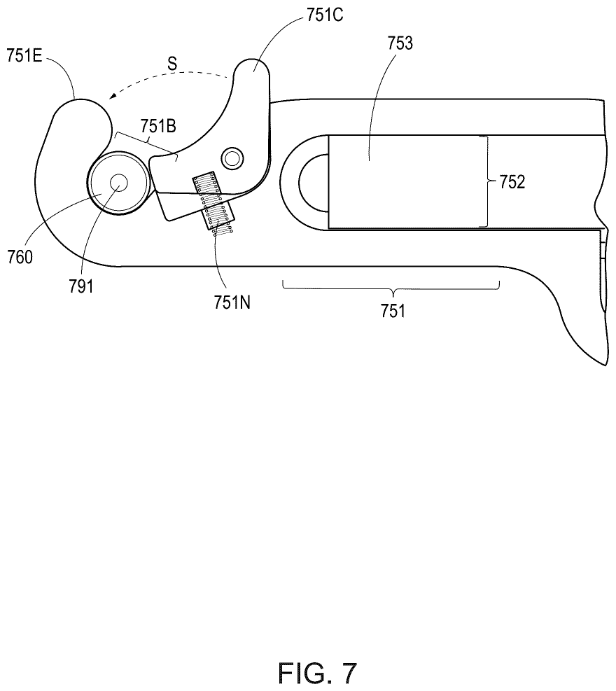

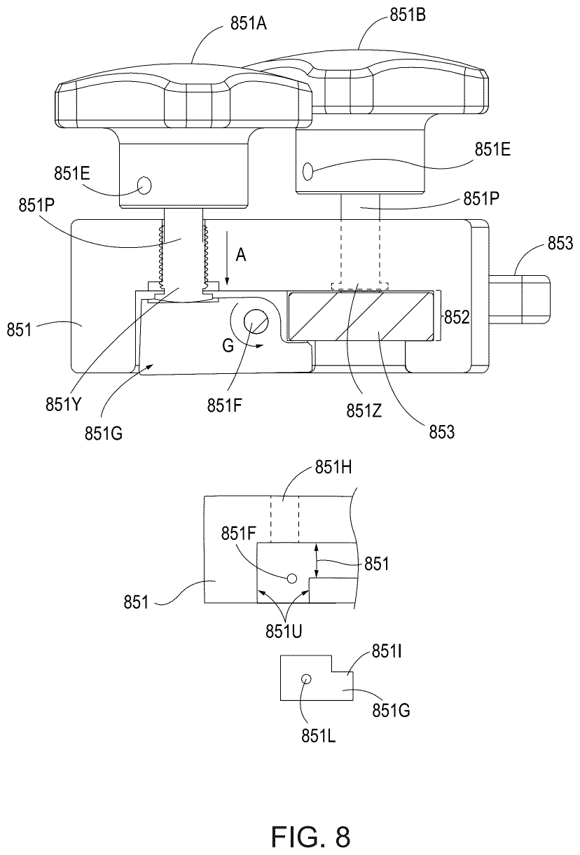

FIG. 6 illustrates another embodiment of the disclosure including a medial side view of proximal clamp 650 comprised of clamp body 651 with table rail acceptance channel 652 formed through part of its length and fitted onto surgical table side rail 653. Proximal clamp 650 has aperture (not shown) formed into its distal end and sized to accept proximal pivot member 691 and has spring loaded toggle arm 751C (See FIG. 7) which when activated can pivot and lock the proximal pivot member 691 in place. Proximal pivot member 691 has catch plate 680A attached to each end (see FIG. 6). Knobs 651A and 651B are attached to threaded stud 651P which is fitted into holes in lateral side of proximal clamp 650 and when tightened can impinge on surgical accessory rail 653 in channel 652. Detail C in FIG. 6 is shown in more detail in FIG. 8, which provides detail of safety latch on proximal clamp 651.

FIG. 7 illustrates another embodiment of the invention including some aspects proximal clamp 751 from Section B-B of FIG. 6. The aspects include aperture 751B formed into the distal end of proximal clamp 751 sized to accept proximal pivot member 760. Toggle arm 751C has spring 751N which allows the toggle arm 751C to be released onto capture proximal pivot member 791 in aperture 751B. Surgical accessory rail 753 is fitted into channel 752 which is formed into the proximal end of proximal clamp 751 and which runs most of the length of the proximal clamp.

FIG. 8 illustrates some aspects of one embodiment of the disclosure namely Detail C of FIG. 6. Knobs 851A and 851B are fitted onto threaded studs 851P and held in place by screws 851P which are inserted in hole (not shown) of the knobs. Threaded ends of threaded studs 851P are fitted into holes (not shown) formed into and through lateral side of proximal clamp 851. Threaded stud 851P of knob 851B can be rotated such that the end 851Z impinges and pushes against a first/outer side of the surgical accessory rail 853 fitted into channel 852 formed into the distal end of proximal clamp 851, thereby removably attaching/securing the proximal clamp 851 to the first/outer side of the surgical accessory rail 853. The middle drawing of FIG. 8 shows aperture 851U which is formed into the distal medial side of proximal clamp 851. Rocker arm 851G with through hole 851L formed therethrough is fitted onto pin 851F. Pin 851F is placed into and fixed into a hole (not shown) formed in aperture 851U. Clamp knob 851A has threaded stud 851P attached to it by screw 851E and is threaded into hole (not shown) formed through the lateral side of proximal clamp 851 and which exits into aperture 851U. Distal end of surgical accessory rail 853 is fitted into channel 852 which is formed into proximal end of proximal clamp 851 and which runs most of the length of the clamp. When knob 851A is tightened, its distal end impinges on rocker arm 851 causing it to tilt so that toe 851N that extends from the rocker arm impinges on a second/inner side of surgical accessory rail 853. This makes it possible to create a tightening force on both the outer and inner sides of the accessory rail 853 using tightening knobs mounted on the outer of the surgical accessory rail, thereby securely attaching the proximal clamp to the surgical accessory rail.

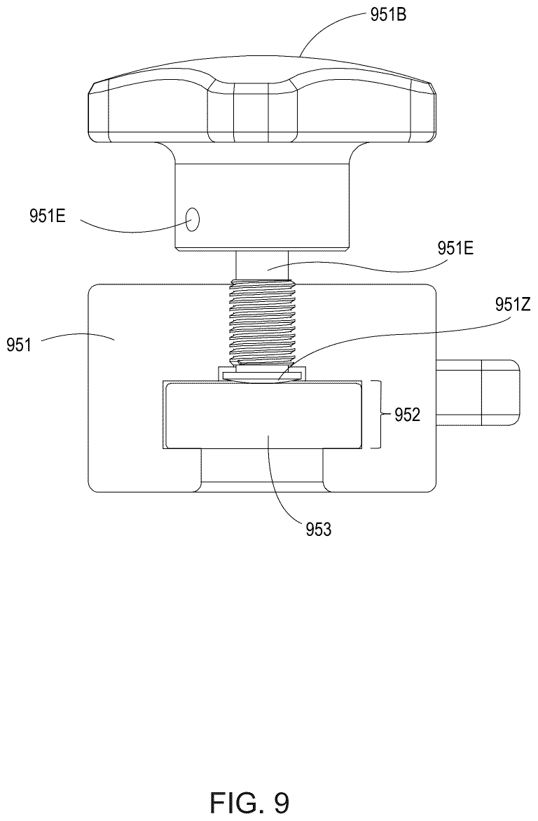

FIG. 9 provides additional aspects of the proximal clamp namely that of knob 951B. Knob 951B has hole 951E in its lower side into which a screw 981E is fitted to secure the knob to a threaded stud 951e with flared end 951Z. Stud 951e is fitted into hole (not shown) formed in a lateral side of clamp body 951. Clamp body 951 has channel 952 formed into its proximal end which runs most of the length of the clamp body. Clamp body 951 is fitted into and onto channel 952. When knob 951B is turned, flared end 951Z pushes against rail 953 in channel 952, thereby locking clamp body 951 to the rail 953.

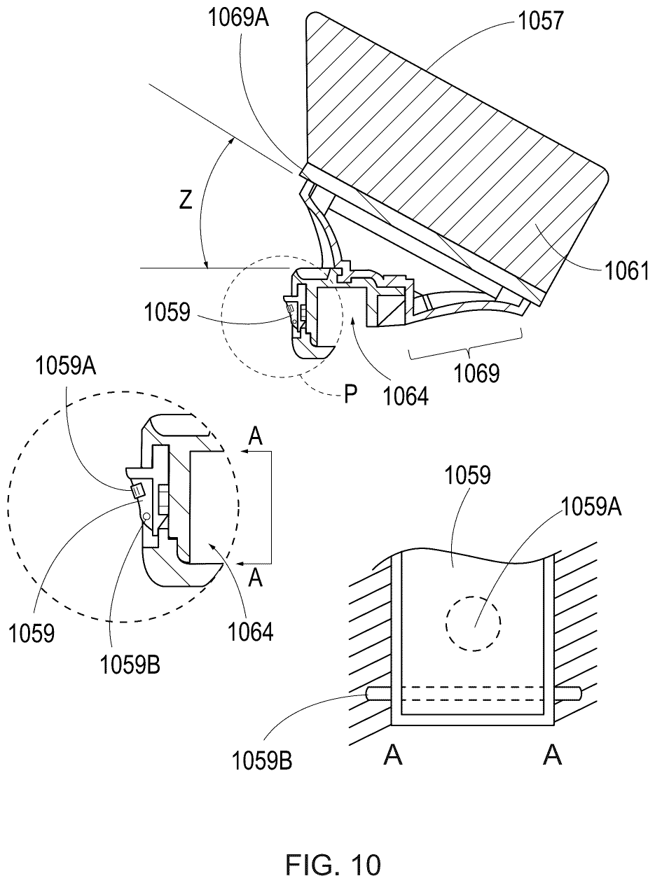

FIG. 10 shows details of one embodiment of the accessory, namely a patient support device 1057 which is an exemplar for accessories support accessories. Patient support device 1057 which comprises a cushion 1061 attached to support mount 1069 with top plate 1069A slanted at angle Z from a generally horizontal line defined by P-P where angle Z may be between 10° and 60°. Channel 1064 is formed through the length of support mount 1069 and sized to fit onto spars (not shown) of frame (not shown). Latch 1059 is spring loaded by spring 1059A biased against spar (not shown) in channel 1064 and attached to support mount 1069 by pin 1959B, as illustrated in section A-A. Latch 1059 is biased against spar (not shown) in channel 1064, thereby locking support mount 1069 against movement of patient support device 1057 from movement along the spar.

FIG. 11 illustrates details an exploded view of components of one aspect an embodiment of the invention. Spar 1104 has threaded holes 1104D formed in its bottom proximal surface. Section T-T shows a view of proximal spar cap 1181 with rectangular hole 1181P formed in its top surface and hole 1181x formed in the center proximal bottom surface and threaded holes 1181K formed in its distal bottom surface and spaced and matching similar holes formed in the proximal region of the bottom surface of spars 1104.

Guard tube 1180 has threaded holes 1180S formed into and through its walls. Threaded bolt 1180T with lug can be passed through hole 1181X and into and through holes 1180Y formed in and through the walls of guard tube 1180 coupling proximal guard tube 1180 and proximal spar cap 1181. Hole 1180Z is formed in proximal surface of proximal spar cap 1181 and is in alignment with through hole 1180S formed in and through the end region of guard tube 1180. Threaded bolt 1180T can pass into and through holes 1181X and 1180S and be capped by lugs thereby securing proximal guard tube 1180 to proximal spar cap 1181.

Distal pivot member 1191 has threads formed into a portion of their circumference. Threaded hole 1191H is formed on an inside end of proximal pivot member 1191. Interior collar 1192 can be fitted onto an inside end of proximal pivot member 1191 while screw 1191A can be passed through a hole in the internal collar and screwed into threaded hole 1191H. The inside end of proximal pivot member 1191 can be slid through through channel 1181N of proximal spar cap 1181 and into guard tube 1180. Internal collar 1180Z can be fit around outside end of proximal pivot member 1191 with threaded hole 1191H. Screw with flat head 1191A may be placed through a hole in external collar 1180Z into and through hole 1180V and then into and through hole in catch plate 1180A and then in and through hole in internal collar 1180T and screwed into hole 1180Q formed into the outside end of proximal pivot member 1191 thus securing the catch plate to the proximal pivot member. Pivot member 1191 can be slid into and through channel 1181N formed through the lateral and medial sides of proximal spar cap 1181. Biased spring latch assembly 1181L with button 1181D can be placed into hole 1189P in proximal spar cap 1181, thereby capturing proximal pivot member 1191.

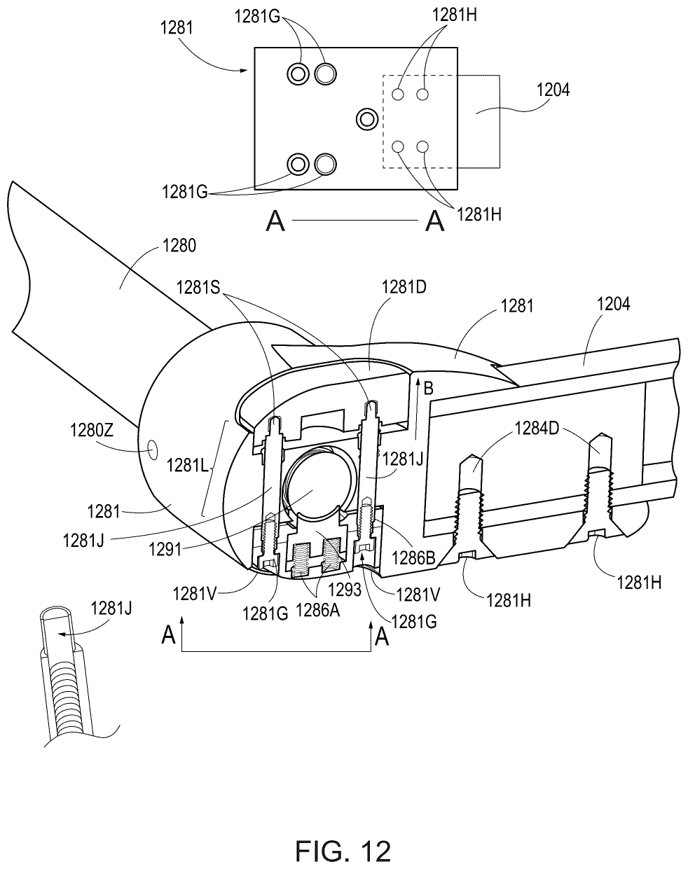

FIG. 12 illustrates some aspects of the disclosure including a side sectional view Q-Q from FIG. 5 of biased actuator assembly 1281L when placed inside hole (not shown) formed in the proximal region of the top surface proximal spar cap 1281.

Actuator button 1281D has threaded holes (not visible) formed into its bottom surface. Bias rods 1281J are threaded on their upper ends and may be screwed into threaded holes (not visible) in bottom surface of actuator button 1281D.

View A-A illustrates a bottom view of an embodiment of proximal spar cap 1281 with threaded bolts 1281G screwed into threaded through holes (not visible) formed into the bottom surface of the spar cap 1281. Bottom surface of spar cap 1281 also has threaded holes 1281V formed through it. Bottom surface of proximal region of spar 1204 has threaded holes 1204D formed into it which match threaded holes 1281H in proximal region bottom surface of proximal spar cap 1281. View A-A shows lay out of holes (not visible) and locations of the ends of threaded bolts 1281G and 1281H.

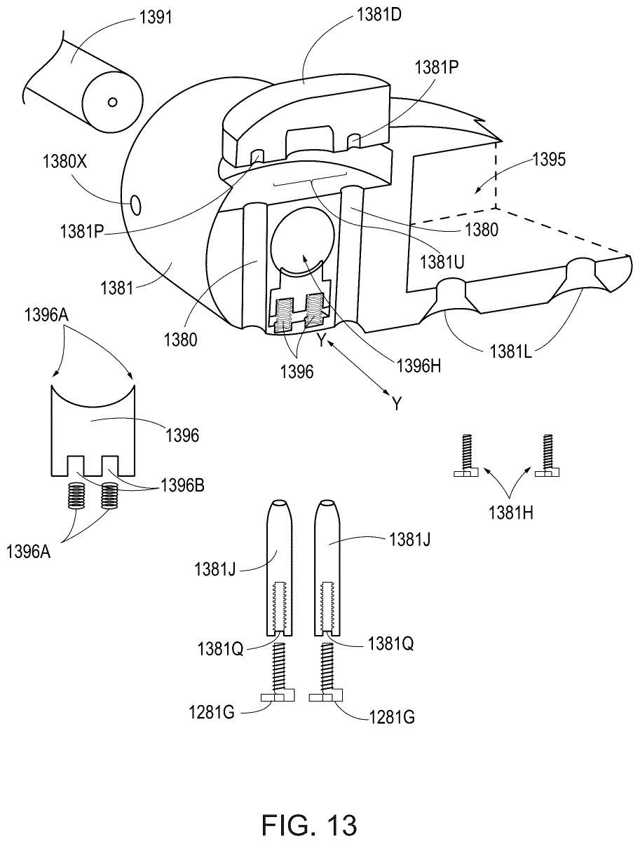

Bias block 1293 has a semi-circular cut out formed in its upper section shaped to accept the outer surface of proximal pivot member 1291. (See FIG. 13 for additional details) Bias block 1293 has holes (not visible) in which springs may be loaded thus biasing the bias block in an upwards direction shown by arrow B. Bias rods 1281J have threaded holes formed in and through their bottom end allowing threaded bolt 1281G to be inserted into holes 1281V in bottom surface of proximal spar cap 1281 and into and through hole formed (not visible) in bottom of bias actuator assembly 1281L and into the threaded hole formed in the bottom end of bias rod 1281J. By threading bolts 1281G into and through holes 1281V in bottom surface of proximal spar 1281 and into and through holes (not visible) in bottom of bias actuator assembly 1281L and thence into threaded holes formed in bottom section of bias rod 1281J, the bias assembly is coupled to proximal spar cap 1281. FIG. 13 provides additional details of an embodiment of bias actuator assembly 1281.

FIG. 13 provides another illustration of sectional view Q-Q of FIG. 5 including proximal spar cap 1381 including cut out 1381U with bolt cut outs 1380 formed into and through its top surface and running the length to the bottom surface of the spar cap. Bolts 1381 may have threaded holes 1381Q formed into its end bottom surface. Cut out 1381U may be formed into the top surface of proximal spar cap 1381 and sized to accept actuation button 1381D. Actuation button 1381D may include cutouts 1381P formed into its bottom surface sized to accept the top end of bolt 1381J. Bolts 1381J may be placed into bolt cut outs 1380 and threaded bolts with caps larger than the bolt cut outs may be screwed into threaded hole 1381Q. Biased element has cutout 1396H formed therein and sized to accept a portion of the circumference of proximal pivot member 1391 and equal in radius to that of lateral hole 1396H formed through the width of proximal spar cap 1381. Springs 1396A can be placed into holes 1396B formed into the bottom of bias member 1396. Bias member 1396 can be placed into cutout (not shown) formed into center bottom surface of lateral hole 1396H with springs 1396A in holes 1396B. When proximal pivot member 1391 is placed into and through lateral hole 1396H, it can be seen that bias member 1396 is biased upwards by springs 1396A, thereby locking it against motion. Depressing or pushing downward on button 1381D releasees bias member 1396 from pushing against distal pivot member 1391, thereby allowing motion of the pivot member in the direction of arrow Y-Y.

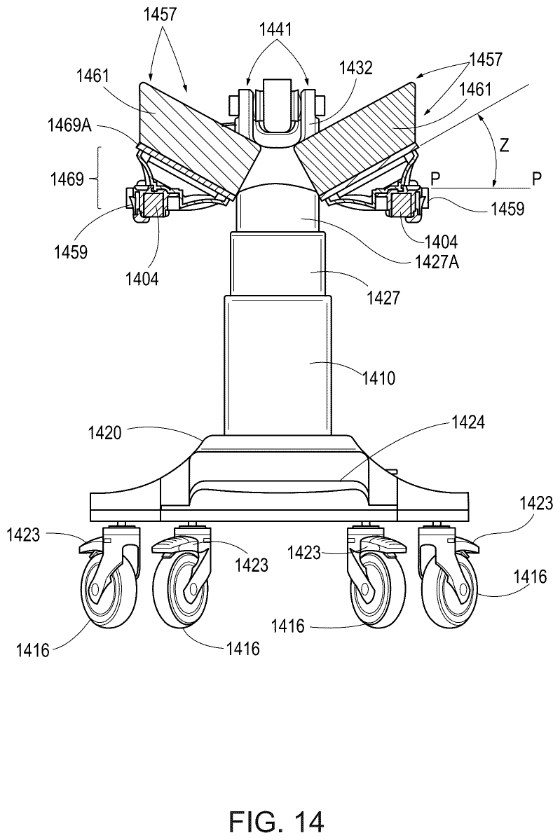

FIG. 14 provides some details of the accessory looking towards the distal end and base of the invention. Base 1420 is supported by castors 1416 and with frame trough 1424 formed into its proximal front surface. In this embodiment, support structure 1410 has adjustment columns 1427 and 1427A nested therein with the adjustment columns able to be extended up and away from the support structure or to be withdrawn downward into the support structure.

Patient support device 1457 is an exemplary for patient support devices. Patient support device 1457 can comprise cushion 1461 attached to support mount 1469 with top plate 1469A slanted at angle Z from a generally horizontal line defined by P-P where angle Z may be between 10° and 60°. Channel (not shown) is formed through the length of support mount 1469 and sized to fit onto spars 1404 onto which it can be slid. Latch 1459 is spring loaded by spring (not shown) biased against spar 1404 in channel (not shown) locking patient support device 1457 against motion along the spar. Multi-axis joint 1441 is coupled to yoke 1432 at its distal end whilst the proximal end of yoke 1432 is attached to distal end of frame (not shown).

Those having ordinary skill in the art will appreciate that various changes can be made to the above embodiments without departing from the scope of the invention.

The above detailed description refers to the accompanying drawings. The same or similar reference numbers may have been used in the drawings or in the description to refer to the same or similar parts. Also, similarly named elements may perform similar functions and may be similarly designed, unless specified otherwise. Details are set forth to provide an understanding of the exemplary embodiments. Embodiments, e.g., alternative embodiments, may be practiced without some of these details. In other instances, well known techniques, procedures, and components have not been described in detail to avoid obscuring the described embodiments.

The foregoing description of the embodiments has been presented for purposes of illustration only. It is not exhaustive and does not limit the embodiments to the precise form disclosed. While several exemplary embodiments and features are described, modifications, adaptations, and other implementations may be possible, without departing from the spirit and scope of the embodiments. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. As used herein, the singular forms “a,” “an,” and “the” may include the plural forms unless the context clearly dictates otherwise. Further, the term “coupled” does not exclude the presence of intermediate elements between the coupled items. Also, stating that a feature may exist indicates that the feature may exist in one or more embodiments.

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or. Moreover, if these terms are used, a subset of a set may include one or more than one, including all, members of the set.

Further, if used in this disclosure, and unless stated or deducted otherwise, a first variable is an increasing function of a second variable if the first variable does not decrease and instead generally increases when the second variable increases. On the other hand, a first variable is a decreasing function of a second variable if the first variable does not increase and instead generally decreases when the second variable increases. In some embodiment, a first variable may be an increasing or a decreasing function of a second variable if, respectively, the first variable is directly or inversely proportional to the second variable.

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Modifications and variations are possible in light of the above teachings or may be acquired from practicing the embodiments. For example, the described steps need not be performed in the same sequence discussed or with the same degree of separation. Likewise various steps may be omitted, repeated, combined, or performed in parallel, as necessary, to achieve the same or similar objectives. Similarly, the systems described need not necessarily include all parts described in the embodiments, and may also include other parts not described in the embodiments. Accordingly, the embodiments are not limited to the above-described details, but instead are defined by the appended claims in light of their full scope of equivalents. Further, the present disclosure is directed toward all novel and non-obvious features and aspects of the various disclosed embodiments, alone and in various combinations and sub-combinations with one another.

While the present disclosure has been particularly described in conjunction with specific embodiments, many alternatives, modifications, and variations will be apparent in light of the foregoing description. It is therefore contemplated that the appended claims will embrace any such alternatives, modifications, and variations as falling within the true spirit and scope of the present disclosure.

What is claimed is:

1. An accessory for attachment to a surgical table that supports at least a portion of a patient's body, the accessory comprising:
at least one support structure having an adjustable length;
a frame extending from a proximal end to a distal end, wherein the distal end of the frame is configured to be rotatably coupled to the surgical table; and
a multi-axis joint mounted onto the at least one support structure rotatably coupled to the proximal end of the frame,
wherein the multi-axis joint has at least a first rotational degree of freedom about a tilt axis of the frame and a second rotational degree of freedom about an axis orthogonal to the tilt axis of the frame

2. The accessory of claim 1, wherein the frame includes two spar members each extending from the proximal end to the distal end of the frame, and each spar member rotatably coupled at a distal end thereof to the surgical table.

3. The accessory of claim 2, further comprising a yoke configured to couple the multi-axis joint to the spar members, such that the multi-axis joint can allow concurrent rotations of the yoke about the tilt axis of the frame and the axis orthogonal to the tilt axis of the frame.

4. An accessory for attachment to a surgical table that supports at least a portion of a patient's body, the accessory comprising:
at least one support structure having an adjustable height;
a frame extending from a proximal end to a distal end, wherein the distal end of the frame is configured to be rotatably coupled to the surgical table;
a multi-axis joint mounted onto the at least one support structure, wherein the multi-axis joint has at least three rotational degrees of freedom; and
a yoke having a proximal end that is coupled to a distal end of the multi-axis joint and a distal end that is rotatably coupled to the proximal end of the frame, wherein the coupling of the distal end of the multi-axis joint to the proximal end of the yoke allows for rotation of the yoke about the at least three rotational degrees of freedom, thereby allowing for rotation of the frame about the at least three rotational degrees of freedom.

5. The accessory of claim 4, further comprising a coupler that pivotably and removably couples the distal end of the frame to the surgical table such that the at least two spar members are able move in response to movement of the surgical table and/or movement of the at least one support structure.

6. The accessory of claim 4, wherein movement of the multi-axis joint about at least two of the t least three rotational degrees of freedom can be simultaneously locked and unlocked.

7. An accessory for attachment to a surgical table that supports at least a portion of a patient's body, the accessory comprising:
at least one support structure extending from a proximal end to a distal end, wherein the proximal end of the at least one support structure is movable along a longitudinal axis of the support structure so as to adjust a length of the at least one support structure;
a frame comprising at least two spar members each extending from a proximal end to a distal end, wherein the distal end of each of the spar members is rotatably coupled to the surgical table;
a multi-axis joint mounted to the proximal end of the support structure,
a yoke rotatably coupled to the proximal end of one of the at least two spar members and rotatably coupled to the proximal end of another one of the at least two spar members such that the yoke is rotatable about an axis substantially orthogonal to a longitudinal axis of each of the spar members;
wherein the multi-axis joint is coupled to the yoke and is configured to allow rotation of the yoke about an axis orthogonal to a tilt axis of the frame concurrently with rotation of the frame about the tilt axis.

8. The accessory of claim 7 further comprising a platform fixedly coupled to the distal end of the at least one support structure.

9. The accessory of claim 7, wherein the at least one support structure has a telescopic beam.

10. The accessory of claim 1, wherein the frame can move about six axes of rotation.

11. The accessory of claim 1, further comprising a rotatable locking head that couples the multi-axis joint to the support structure, wherein the rotatable locking head is rotatable about a longitudinal axis of the support structure.

12. The accessory of claim 11, wherein the rotatable locking head comprises a lever that is movable between a first position and a second position, wherein when the lever is in the first position, the rotatable locking head is rotatable, and when the lever is in the second position, the rotatable lockable head is locked against rotation.

13. The accessory of claim 1, wherein the surgical table allows the frame to move or articulate about six axes of rotation.

14. The accessory of claim 1, wherein the frame is a rectilinear frame comprising radiolucent members.

15. The accessory of claim 1, further comprising a lockable rotatable head attached to a top surface of the support structure, the rotatable head being configured to rotate around a perpendicular axis to the floor and which runs down the center of the adjustment column and the support column and the floor, wherein a distal portion of a multi-axis joint is coupled.

16. The accessory of claim 4, further comprising a lockable rotatable head attached to a top surface of the support structure, the rotatable head being configured to rotate around a perpendicular axis to the floor and which runs down the center of the adjustment column and the support column and the floor, wherein a distal portion of a multi-axis joint is coupled.

17. The accessory of claim 7, further comprising a lockable rotatable head attached to a top surface of the support structure, the rotatable head being configured to rotate around a perpendicular axis to the floor and which runs down the center of the adjustment column and the support column and the floor, wherein a distal portion of a multi-axis joint is coupled.

18. The accessory of claim 1, wherein the multi-axis joint comprises a main clamp having a circular cutout formed therein, a rotational hub having a through hole formed therein, a yoke pivot member configured to be rotatably fit in the through hole, semisphericals configured to be placed around the circumference of the rotational hub and positioned within the circular cutout, wherein the yoke is rotationally coupled to the yoke pivot member to allow rotation of the yoke about the yoke pivot member.

19. The accessory of claim 4, wherein the multi-axis joint comprises a main clamp having a circular cutout formed therein, a rotational hub having a through hole formed therein, a yoke pivot member configured to be rotatably fit in the through hole, semisphericals configured to be placed around the circumference of the rotational hub and positioned within the circular cutout, wherein the yoke is rotationally coupled to the yoke pivot member to allow rotation of the yoke about the yoke pivot member.

20. The accessory of claim 7, wherein the multi-axis joint comprises a main clamp having a circular cutout formed therein, a rotational hub having a through hole formed therein, a yoke pivot member configured to be rotatably fit in the through hole, semisphericals configured to be placed around the circumference of the rotational hub and positioned within the circular cutout, wherein the yoke is rotationally coupled to the yoke pivot member to allow rotation of the yoke about the yoke pivot member.

21. An accessory for attachment to a surgical table that supports at least a portion of a patient's body, the accessory comprising:
at least one support structure having an adjustable length;
a frame extending from a proximal end to a distal end, wherein the distal end of the frame is configured to be rotatably coupled to the surgical table; and
at least two or more joints mounted onto the at least one support structure rotatably coupled to the proximal end of the frame, wherein the at least two or more joints have at least a first rotational degree of freedom about a tilt axis of the frame and a second rotational degree of freedom about an axis orthogonal to the tilt axis of the frame.

22. A clamp configured to attach to a surgical accessory rail having an outer and inner side, the clamp comprising:
a clamp body having a table rail acceptance channel formed therein configured to receive the surgical accessory rail, and first and second holes formed in the clamp body;
first and second threaded screws extending through the first and second holes, respectively;
a first knob fitted onto the first threaded screw, wherein rotation of the first knob causes an end of the first threaded screw to impinge upon an outer side of the surgical accessory rail, thereby securing the clamp to the outer side of the surgical accessory rail;
rocker arm having a toe that extends from the rocker arm; and
a second knob fitted onto the second threaded screw, wherein rotation of the second knob causes an end of the second threaded screw to impinge upon the rocker arm causing the rocker arm to tilt so that a surface of the toe impinges on an inner side of the surgical accessory rail, thereby securing the clamp to the inner side of the surgical accessory rail.
